(19) United States
(12) Patent Application Publication
(10) Pub. No.: US 2015/0277601 A1
(43) Pub. Date: Oct. 1, 2015

(54) SPECIFIED POSITION DETECTION DEVICE

(71) Applicants: Kenji Tahara, Saitama (JP); Yasushi Sekizawa, Saitama (JP)

(72) Inventors: Kenji Tahara, Saitama (JP); Yasushi Sekizawa, Saitama (JP)

(21) Appl. No.: 14/432,138

(22) PCT Filed: Dec. 3, 2013
(86) PCT No.: PCT/JP2013/007081

§ 371 Date: Mar. 27, 2015

(30) Foreign Application Priority Data
Sep. 28, 2012 (GB) 1217390.2

(51) Int. Cl. G06F 3/041; G06F 3/0354

(52) U.S. Cl. CPC G06F 3/041; G06F 3/03545; G06F 2203/04101

(57) ABSTRACT

To easily detect a touched coordinate position to an XY coordinate forming unit.

For an XY coordinate forming unit 11 formed by mutually crossing linear bodies respectively formed by a plurality of linear bodies, a drive signal input unit 21 and a position detection signal output unit 31 are provided. A drive signal is input from the drive signal input unit 21 to the XY coordinate forming unit 11 having crossing configuration, and when a position is specified to the XY coordinate forming unit 11 having crossing configuration with a position specifying means 5 or 6, a specified position detection signal is obtained from the position detection signal output unit 31, and a specified position detection mode of the XY coordinate forming unit 11 is switched to a static coupling system or an inductive coupling system by mode switching units 12 and 13. Therefore, it is possible to realize a specified position detection device with a simple configuration.

### TECHNICAL FIELD

The present invention relates to a specified position detection device, and is suitably applied to an information processing device having a tablet display surface, for example.

### BACKGROUND ART

An information processing device having a tablet display surface is frequently used as a means to enable a user to specify a specific display position on an operation display surface and easily carry out processing of information corresponding to the display position.

As for this kind of information processing device, as detection means for detecting a position specified by a user on the operation display surface, what is proposed is an electromagnetic system that is so configured as to detect, when a position specifying tool containing a parallel resonance circuit, a magnetic substance, and the like is brought closer to a coordinate position on the display surface with a large number of loop coils provided in the operation display surface, the coordinate position as a position specified by the user (See Patent Documents 1 and 2).

As another specified position detection means, what is proposed is an electrostatic capacity system that is so configured as to detect, when a user's finger is brought into electrostatic capacity coupling on a plurality of X electrodes and Y electrodes crossing thereto, the two-dimensional coordinates of a touched position of a touch panel (See Patent Documents 3 and 4).

### PRIOR ART DOCUMENTS

### Patent Documents

[Patent Document 1] Japanese Patent Application Laid-open Publication No. 7-44304

[Patent Document 2] Japanese Patent Application Laid-open Publication No. 2010-85378

[Patent Document 3] Japanese Patent Application Laid-open Publication No. 2010-176571

[Patent Document 4] Japanese Patent Application Laid-open Publication No. 2013-131079

### SUMMARY OF THE INVENTION

### Problems to be Solved by the Invention

In an information processing device having a tablet display surface, as to detection of a position specified by a user on an operation display surface, enabling of maintaining the highest possible detection accuracy with the simplest configuration possible is effective as a means for improving practicality of an information processing device. Also, it is considered that if combining information input operation with finger and information input operation with pen-type position specifying tool, various kinds of information can be easily input from an operation display surface.

The present invention has been made in view of the above points, and is to provide a specified position detection device that can easily input various kinds of information with high position detection accuracy.

### Means for Solving the Problems

To solve the above problems, the present invention provides an XY coordinate forming unit 11 having a configuration mutually crossing X-axis linear bodies X1-XN formed by a plurality of linear bodies and Y-axis linear bodies Y1-YM formed by a plurality of linear bodies; a drive signal input unit 21, provided on either one terminal side of the X-axis linear bodies X1-XN and Y-axis linear bodies Y1-YM, for inputting a drive input signal; a position detection signal output unit 31, provided on either the other terminal side of the X-axis linear bodies X1-XN and Y-axis linear bodies Y1-YM, when an XY coordinate position on the XY coordinate forming unit 11 is specified with a position specifying means 5 or 6, for outputting a position detection signal corresponding to the specified coordinate position; and mode switching units for switching a specified position detection mode of the XY coordinate forming unit 11 to a static coupling system or an inductive coupling system.

Furthermore, the present invention provides an XY coordinate forming unit 11 having a configuration mutually crossing X-axis linear bodies X1-XN formed by a plurality of linear bodies and Y-axis linear bodies Y1-YM formed by a plurality of linear bodies; a drive signal input unit 21, provided on either one terminal side of the X-axis linear bodies X1-XN and Y-axis linear bodies Y1-YM, for inputting a drive input signal; a position detection signal output unit 31, provided on either the other terminal side of the X-axis linear bodies X1-XN and Y-axis linear bodies Y1-YM, when an XY coordinate position on the XY coordinate forming unit 11 is specified with a position specifying means 5 or 6, for outputting a position detection signal corresponding to the specified coordinate position; a first mode switching unit 12 provided on the other terminal side of the X-axis linear bodies X1-XN and Y-axis linear bodies Y1-YM in that the drive signal input unit 21 is not provided; and a second mode switching unit 21 provided on the other terminal side of the X-axis linear bodies X1-XN and Y-axis linear bodies Y1-YM in that the position detection signal output unit 31 is not provided. The drive signal input unit 21 sequentially selects two from among each the one terminal of the connected linear bodies and inputs the drive input signal thereto, and the first mode switching unit 12 respectively connects each the other terminal of the above two sequentially-selected linear bodies, and forming a loop coil LI1-LIK for input signal input by the above two linear bodies; the position detection signal output unit 31 sequentially selects two from among the connected linear bodies and outputs the position detection signal thereto, and the second mode switching unit 13 connects each the other terminal of the above two selected linear bodies, and forming a loop coil LO1-LOJ for position detection signal output by the above two linear bodies; and when an XY coordinate position on the XY coordinate forming unit 11 is specified with the position specifying means 6 of pen touch type, an input signal input from the formed loop coil LI1-LIK for input signal input is transmitted to the loop coil LO1-LOJ for position detection signal output via the position specifying means 6, and outputting the signal from the position detection signal output unit 31 as a pen touch operation detection output in an inductive coupling detection mode.

Furthermore, the present invention provides an XY coordinate forming unit 11 having a configuration mutually crossing X-axis linear bodies X1-XN formed by a plurality of linear bodies and Y-axis linear bodies Y1-YM formed by a plurality of linear bodies; a drive signal input unit 21, provided on either one terminal side of the X-axis linear bodies X1-XN and Y-axis linear bodies Y1-YM, for inputting a drive input signal; a position detection signal output unit 31, provided on either the other terminal side of the X-axis linear bodies X1-XN and Y-axis linear bodies Y1-YM, when an XY coordinate position on the XY coordinate forming unit 11 is specified with a position specifying means 5, for outputting a position detection signal corresponding to the specified coordinate position; a first mode switching unit 12 provided on the other terminal side of the X-axis linear bodies X1-XN and Y-axis linear bodies Y1-YM in that the drive signal input unit 21 is not provided; and a second mode switching unit 13 provided on the other terminal side of the X-axis linear bodies X1-XN and Y-axis linear bodies Y1-YM in that the position detection signal output unit 31 is not provided. In the operating state that the linear bodies are unconnected by the first and second mode switching units 12 and 13, the drive signal input unit 21 sequentially inputs the drive input signal to one terminal of the connected linear bodies, and when an XY coordinate position on the XY coordinate forming unit 11 is specified with a user's finger as the position specifying means 5, the drive input signal which is input from the drive signal input unit 21 and transmitted while undergoing change of stray capacitance between the linear bodies occurred by the user's finger is output from the position detection signal output unit 31 as a finger touch operation detection output in a static coupling detection mode.

### Advantageous Effect of the Invention

According to the present invention, for an XY coordinate forming unit formed by linear bodies mutually crossing and respectively composed of a plurality of linear bodies, a drive signal input unit and a position detection signal output unit are provided. It is designed to input a drive signal from the drive signal input unit to the XY coordinate forming unit having single configuration, and when a user specified a position on the XY coordinate forming unit having single configuration with a position specifying means, to obtain a specified position detection signal from the position detection signal output unit, at the same time, to switch a specified position detection mode of the XY coordinate forming unit to a static coupling system or an inductive coupling system by mode switching units. Therefore, it is possible to realize a specified position detection device with a simple configuration.

### BRIEF DESCRIPTION OF THE DRAWINGS

FIG. 1 is a block diagram showing an overall configuration of an information processing device adapted to a specified position detection device of the present invention.

FIG. 2 is a schematic diagram showing a detailed configuration of a tablet display plate unit 3 of FIG. 1.

FIG. 3 is an electric schematic diagram showing a detailed configuration of a specified position detection unit 4 of FIG. 1.

FIG. 4 is an electric schematic diagram showing an XY coordinate forming unit 11 of FIG. 3.

FIG. 5 is a schematic diagram used for explanation of an inductive coupling type XY coordinate system formed by an XY coordinate forming unit 11 of FIG. 4.

FIG. 6 is an electric block diagram showing a detailed configuration of a synchronous detection circuit 37 of FIG. 3.

FIG. 7 is a schematic diagram used for explanation of a static coupling type XY coordinate system formed by the XY coordinate forming unit 11.

FIG. 8 is a schematic diagram used for explanation of touch operation with a finger to the static coupling type XY coordinate system of FIG. 7.

FIG. 9 is a flowchart showing a specified position detection mode switching processing procedure.

FIG. 10 is a signal waveform diagram used for explanation of a standby detection operation mode processing SP1 of FIG. 9.

FIG. 11 is a flowchart showing a detailed configuration of a fixed detection mode processing procedure SP3 of FIG. 9.

FIG. 12 is a signal waveform diagram used for explanation of a static coupling fixed detection processing procedure SP12 of FIG. 11.

FIG. 13 is a signal waveform diagram used for explanation of an inductive coupling fixed detection processing procedure SP14 of FIG. 11.

FIG. 14 is a flowchart showing a detailed configuration of a priority detection mode processing procedure SP5 of FIG. 19.

FIG. 15 is a signal waveform diagram used for explanation of a standby operation processing procedure SP21 of FIG. 14.

FIG. 16 is a signal waveform diagram used for explanation of switching from standby operation to static coupling priority operation.

FIG. 17 is a signal waveform diagram used for explanation of switching from standby operation to inductive coupling priority operation.

FIG. 18 is a flowchart showing a detailed configuration of a static coupling priority processing procedure SP23 of FIG. 14.

FIG. 19 is a signal waveform diagram used for explanation of static coupling priority detection operation.

FIG. 20 is a flowchart showing a detailed configuration of an inductive coupling priority processing procedure SP24 of FIG. 14.

FIG. 21 is a signal waveform diagram used for explanation of switching of operation from static coupling priority control to inductive coupling priority operation.

FIG. 22 is a flowchart showing a detailed configuration of a static priority switching check processing procedure SP47 of FIG. 20.

FIG. 23 is a signal waveform diagram used for explanation of static priority switching check processing operation.

### EMBODIMENTS FOR CARRYING OUT THE INVENTION

### (1) Overall Configuration of Information Processing Device

In FIG. 1, reference numeral 1 represents an information processing device according to a first embodiment as a whole. A central processing unit 2 exchanges an information display signal S1 with a tablet display plate unit 3. In a specified position detection unit 4 that contains the tablet display plate unit 3, when a user specifies a specific position on an XY display surface of the tablet display plate unit 3 by touching or closing to the display surface of the tablet display plate unit 3 with his/her finger 5 (this is referred to as “finger touch operation”) or touching or closing a pen-shaped position specifying tool 6 (this is referred to as “pen touch operation”), a specified position detection signal S2, which indicates the specified position, is output from a specified position detection control unit 7 to the central processing unit 2. Then the central processing unit 2 carries out a variety of information processing.

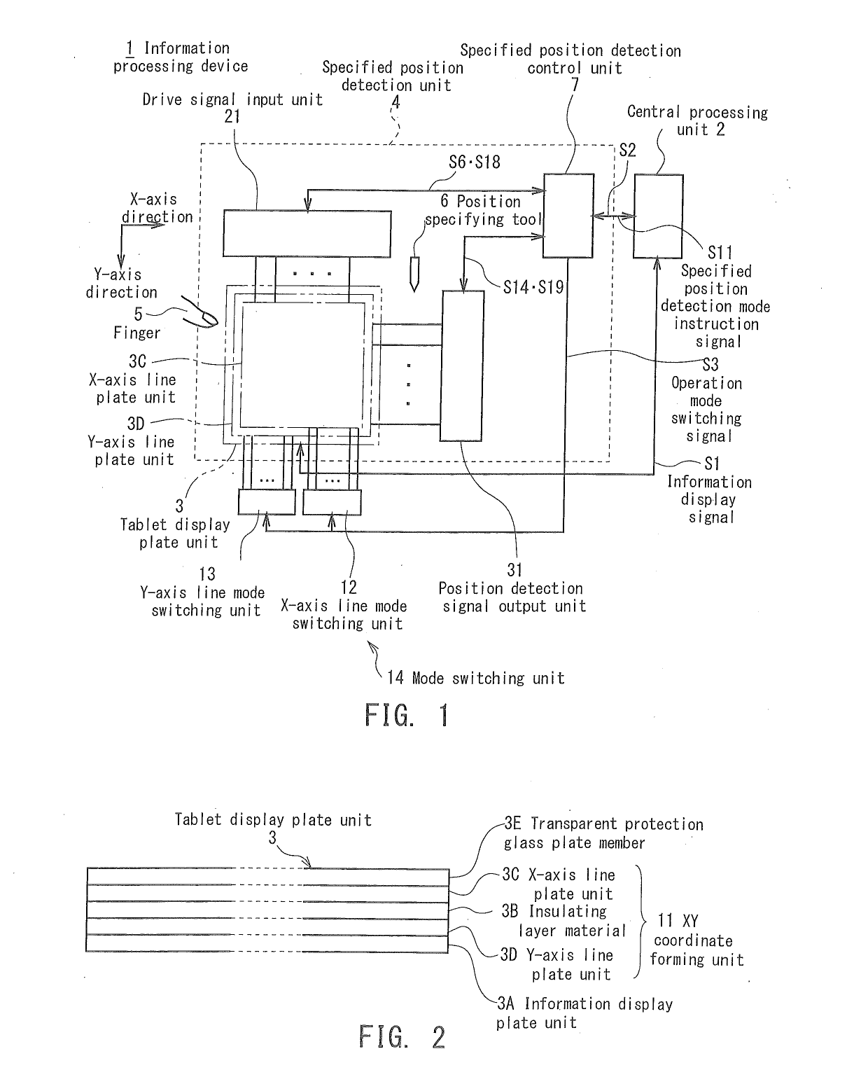

In the case of this embodiment, as shown in FIG. 2, the tablet display plate unit 3 has such configuration that an X-axis line plate unit 3C and Y-axis line plate unit 3D which are laminated with sandwiching insulating layer material 3B therebetween on an information display plate unit 3A which displays the information display signal S1 given from the central processing unit 2, and the X-axis line plate unit 3C and Y-axis line plate unit 3D, thus laminated as single configuration, are protected by transparent protection glass plate member 3E that forms an operation display surface.

Therefore, in the tablet display plate unit 3, the user can read information display displayed on the information display plate unit 3A from the transparent protection glass plate member 3E side, and can specify specific information display material with the user's finger 5 or the pen-shaped position specifying tool 6.

### (2) Coordinate Position Specification Input Means

In the case of this embodiment, in the tablet display plate unit 3, the XY coordinate forming unit 11 is formed by the X-axis line plate unit 3C, insulating layer material 3B and Y-axis line plate unit 3D as coordinate position specification input means. In the XY coordinate forming unit 11, by an operation mode switching signal S3 that is supplied from a specified position detection control unit 7 to an X-axis line mode switching unit 12 and a Y-axis line mode switching unit 13, an inductive coupling type specified position detection operation mode and a static coupling type specified position detection operation mode can be carried out freely switchably.

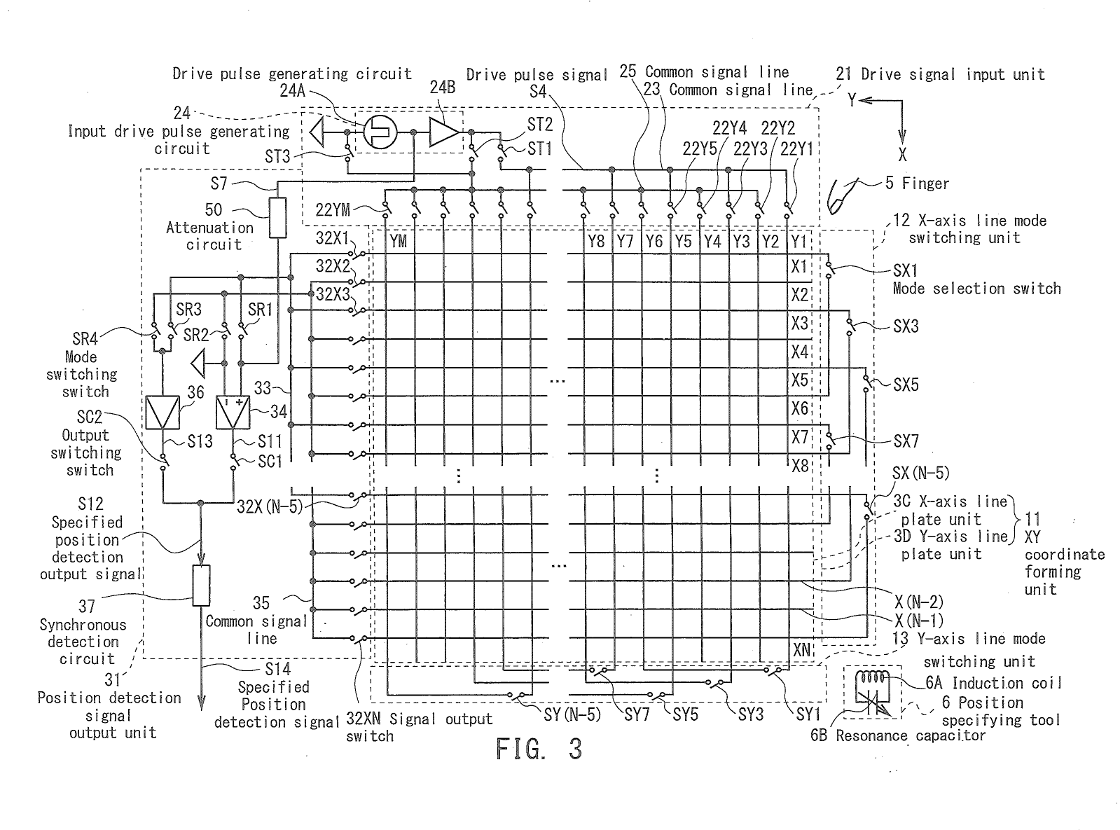

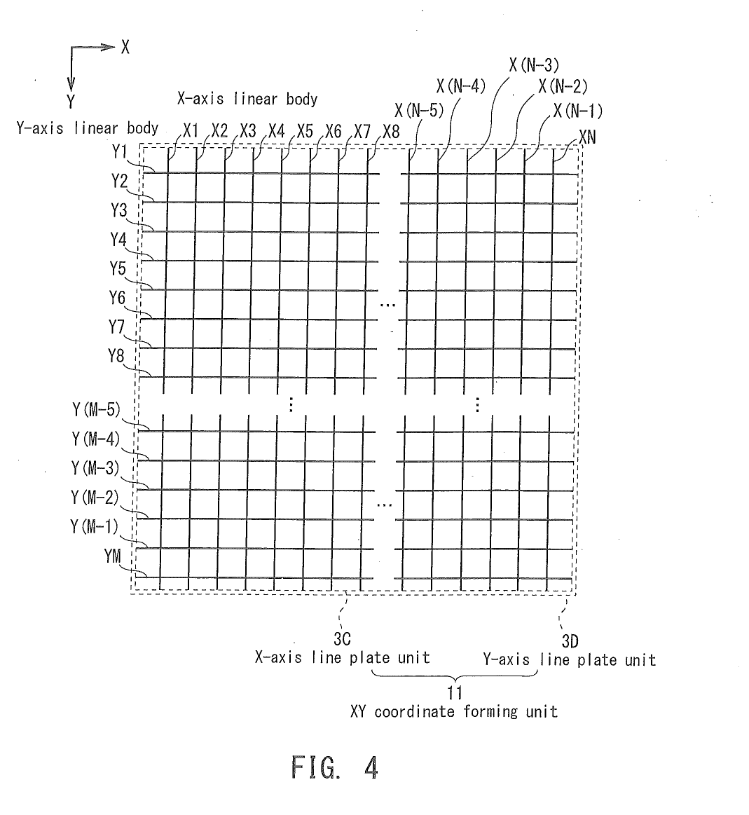

As shown in FIGS. 3 and 4, the X-axis line plate unit 3C constituting the XY coordinate forming unit 11 in the tablet display plate unit 3 has plural N (for example 32) linear X-axis linear bodies X1, X2 . . . XN, which linearly extend to the Y-axis direction and are disposed in mutually parallel at equal intervals in the X-axis direction.

Whereas, the Y-axis line plate unit 3D has plural M (for example 20) linear Y-axis linear bodies Y1, Y2 . . . YM, which linearly extend to the X-axis direction and are disposed in mutually parallel at equal intervals in the Y-axis direction.

In this manner, in the XY coordinate forming unit 11 having the X-axis line plate unit 3C and Y-axis line plate unit 3D, in that the X-axis linear bodies X1, X2 . . . XN and Y-axis linear bodies Y1, Y2 . . . YM are mutually orthogonally crossing and laminated with sandwiching the insulating layer material 3B therebetween, a coordinate position can be specified by the point of intersection between the X-axis linear bodies X1, X2 . . . XN and Y-axis linear bodies Y1, Y2 . . . YM, as an XY coordinate position on the display surface of the tablet display plate unit 3, namely, the operation display surface of the transparent protection glass plate member 3E.

As shown in FIG. 3, each one terminal of the Y-axis linear bodies Y1, Y2 . . . Y(M−3), Y(M−2), Y(M−1), YM of the Y-axis line plate unit 3D (FIG. 4) is connected to signal input switches 22Y1, 22Y2 . . . 22Y(M−3), 22Y(M−2), 22Y(M−1), 22YM, which are semiconductor switches so provided as to correspond thereto in the drive signal input unit 21.

Among the signal input switches 22Y1, 22Y2 . . . 22YM, each the other terminal of the alternate signal input switches 22Y1, 22Y3, 22Y5 . . . 22Y (M−5) is connected to a common signal line 23. The common signal line 23 is connected to an input drive pulse generating circuit 24 through a mode switching switch ST1. In this manner, a drive pulse signal S4, which is generated in a drive pulse generating circuit 24A of the input drive pulse generating circuit 24 is supplied to the common signal line 23 via an amplifier circuit 24B.

Remaining signal input switches 22Y2, 22Y4 . . . 22Y(M−4), 22Y(M−3), 22Y(M−2), 22Y(M−1) and 22YM of the signal input switches 22Y1, 22Y2 . . . 22YM are connected to a common signal line 25. The common signal line 25 is connected to the output terminal of the amplifier circuit 24B of the input drive pulse generating circuit 24 through a mode switching switch ST2, and is also connected to a ground through a mode switching switch ST3.

In this manner, as described later, in an inductive coupling type specified position detection operation mode, when the mode switching switches ST1 and ST3 are turned on based on a control signal S6 which is supplied from the specified position detection control unit 7, a drive pulse signal S4 is supplied from the common signal line 23 to the Y-axis linear bodies, and is also led from the common signal line 25 and flown to the ground, to make the Y-axis linear bodies function as a Y-axis loop coil that is electromagnetic drive input means in the inductive coupling type specified position detection operation mode.

Whereas, in a static coupling type specified position detection operation mode, when the mode switching switches ST1 and ST2 are turned on, a drive pulse signal S4, which is transmitted from the input drive pulse generating circuit 24, is supplied to all the Y-axis linear bodies Y1, Y2 . . . YM through the common signal lines 23 and 25, to make the Y-axis linear bodies function as static drive input means in the static coupling type specified position detection mode.

Each one terminal of the X-axis linear bodies X1, X2 . . . XN of the X-axis line plate unit 3C is connected to signal output switches 32X1, 32X2 . . . 32XN, which are so provided as to correspond thereto in the position detection signal output unit 31.

Among the signal output switches 32X1, 32X2 . . . 32XN, the alternate signal output switches 32X1, 32X3, 32X5 . . . 32Y(N−5) are connected to a common signal line 33. The common signal line 33 is connected to a non-inverting input terminal of an inductive coupling signal output circuit 34 having a configuration of differential amplifier circuit through the mode switching switch SR1.

Moreover, remaining signal output switches 32X2, 32X4, . . . 32X(N−4), 32X(N−3), 32X(N−2), 32X(N−1), 32XN of the signal output switches 32X1, 32X2 . . . 32XN are connected to a common signal line 35. The common signal line 35 is connected to an inverting input terminal of the inductive coupling signal output circuit 34 through a mode switching switch SR2, together with a ground line.

In this manner, as described later, in the inductive coupling type specified position detection operation mode, when the mode switching switches SR1 and SR2 are turned on, specified position detection signals flow through the common signal lines 33 and 35, to make the X-axis linear bodies function as an X-axis loop coil in the inductive coupling type specified position detection operation mode.

Thereby, an inductive coupling detection signal S11 which is obtained at the output terminal of the inductive coupling signal output circuit 34 is output through an output switching switch SC1 as a specified position detection output signal S12.

Whereas, the common signal lines 33 and 35 are connected to the input terminal of a static coupling signal output circuit 36 through mode switching switches SR3 and SR4 respectively. A static coupling detection signal S13 which is obtained at the output terminal is output through the output switching switch SC2 as a specified position detection output signal S12, to make the X-axis linear bodies function as static drive output means in the static coupling type specified position detection mode.

The specified position detection output signal S12 is subjected to synchronous detection processing in the synchronous detection circuit 37, and then is transmitted to the specified position detection control unit 7 as a specified position detection signal S14 of the position detection signal output unit 31.

### (3) Mode Switching Unit 14

A mode switching unit 14 is composed of the X-axis line mode switching unit 12 and Y-axis line mode switching unit 13 of FIG. 3, and by using the X-axis linear bodies X1 to XN disposed on the X-axis line plate unit 3C and the Y-axis linear bodies Y1 to YM provided as crossing to the X-axis linear bodies X1 to XN on the Y-axis line plate unit 3D, enables to execute an inductive coupling type specified position detection operation mode and a static coupling type specified position detection operation mode with the XY coordinate forming unit 11 having a single plate constitution.

In the case of this embodiment, in the X-axis line mode switching unit 12, among the N (N=32) X-axis linear bodies disposed in the X-axis direction, mode selection switches SX1, SX3, SX5 . . . SX(N−5) are respectively provided between each one terminal of the two linear bodies X1 and X6, X3 and X8, X5 and X10, . . . , X(N−5) and XN in which there are four X-axis linear bodies therebetween.

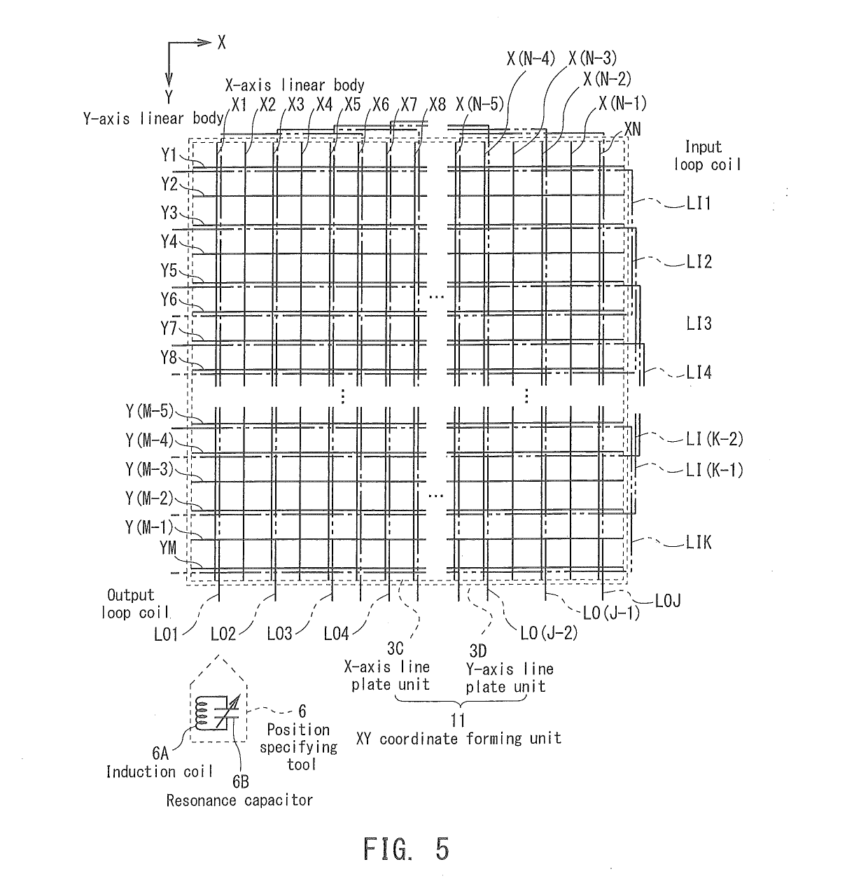

In this manner, as to the X-axis linear bodies X1 to XN, when the mode selection switches SX1, SX3, SX5 . . . SX(N−5) are turned on, the X-axis line mode switching unit 12 connects the X-axis linear bodies X1 and X6, X3 AND X8, X5 AND X10, . . . , and X(N−5) and XN, and as shown in FIG. 5, forming output loop coils LO1, LO2 . . . LOJ which extend vertically in the Y-axis direction.

Similarly, as to the Y-axis linear bodies Y1 to YM, mode selection switches SY1, SY3, SY5 . . . SY(M−5) are respectively provided between each the other terminal of the Y-axis linear bodies Y1 and Y6, Y3 and Y8, Y5 and Y10, . . . , Y(M−5) and YM. When these mode selection switches are turned on, the Y-axis line mode switching unit 13 mutually connects these Y-axis linear bodies, and forming input loop coils LI1, LI2, L13 . . . LIK which are vertically long in the X-axis direction by the pairs of Y-axis linear bodies Y1 and Y6, Y3 and Y8, Y5 and Y10, . . . , YM(M−5) and YM, as orthogonally crossing to the output loop coils LO1, LO2 . . . LOJ formed by the X-axis line plate unit 3C.

In this manner, in the X-axis line plate unit 3C and Y-axis line plate unit 3D, by respectively closing the mode selection switches SX1, SX3, SX5 . . . SX(N−5) of the X-axis line mode switching unit 12 and also the mode selection switches SY1, SY3, SY5 . . . SY (M−5) in the Y-axis line mode switching unit 13, XY coordinate system is formed on the XY coordinate forming unit 11. Thereby, such inductive coupling type specified position detection operation mode can be set that when a user specifies a coordinate position with a pen type position specifying tool 6 based on inductive coupling system, an inductive coupling type specified position detection signal S14 can be transmitted from the position detection signal output unit 31.

### (4) Configuration of Specified Position Detection Operation Mode by Inductive Coupling System

When a user specified the inductive coupling type specified position detection operation mode, the central processing unit 2 controls the X-axis line mode switching unit 12 and Y-axis line mode switching unit 13 of the mode switching unit 14 via the specified position detection control unit 7 to form the input loop coils LI1, LI2 . . . LIK and output loop coils LO1, LO2 . . . LOJ (FIG. 5), and switches the drive signal input unit 21 and position detection signal output unit 31 to an inductive coupling detection operation mode (FIG. 3).

A specified position detecting operation in the XY coordinate forming unit 11 at this time is referred to as “inductive coupling detecting operation”.

At this time, the drive signal input unit 21 turns on the mode switching switches ST1 and ST3, and sequentially turns on the signal input switches 22Y1 and 22Y6, 22Y3 and 22Y8, . . . 22Y(M−5) and 22YM in a reference detection cycle. Thereby, drive input current is sequentially flown to the input loop coils LI1, LI2 . . . LIK to generate an inductive electromagnetic field on the Y-axis line plate unit 3D.

In this state, the user carries out “pen touch operation” on the XY coordinate surface of the XY coordinate forming unit 11 with a pen type position specifying tool 6 and specifies a coordinate position.

In the case of this embodiment, the position specifying tool 6 has a resonance circuit composed of an induction coil 6A and a resonance capacitor 6B. By an electromagnetic field generated by one of the input loop coils LI1, LI2 . . . LIK which is at the position that the user carried out “pen touch operation”, synchronous resonance current is raised on the induction coil 6A and resonance capacitor 6B, and induces an induction voltage on one of the output loop coils LO1, LO2 . . . LOJ which is at the position performed the “pen touch operation” based on an inductive electromagnetic field, which is generated on the induction coil 6A based on the synchronous resonance current.

At the time, the position detection signal output unit 31 receives a detected voltage based on the induction voltage in the inductive coupling signal output circuit 34 from the signal output switches 32X1 and 32X6, 32X3 and 32X8, . . . , 32X(N−5) and 32XN connected to the output loop coils LO1, LO2 . . . LOJ, through the mode switching switches SR1 and SR2, and outputs this through the output switching switch SC1 as a specified position detection output signal S12.

In the case of this embodiment, an on-operation period of the signal output switches 32X1 and 32X6, 32X3 and 32X8, . . . , 32X(N−5) and 32XN of the position detection signal output unit 31 is selected as a timing that makes one cycle during each on-operation period of the signal input switches 22Y1 and 22Y6, 22Y3 and 22Y8, . . . , 22Y(M−5) and 22YM of the drive signal input unit 21. Thereby, during each drive period in that a drive input pulse current flows respectively to the input loop coils LI1, LI2 . . . LIK, a position detection output can be obtained from all of the output loop coils LO1, LO2 . . . LOJ (including the output loop coil carried out the “pen touch operation”.

In the case of this embodiment, the value of the resonance capacitor 6B of the position specifying tool 6 is constituted to vary corresponding to pen pressure at the time when the user pressed the pen nib to an operation display surface of the transparent protection glass plate member 3E of the XY coordinate forming unit 11 (FIG. 2) to specify a position. By utilizing thereby varying the phase of synchronous tuning resonance current raised on the position specifying tool 6, i.e. the phase of induction voltages of the output loop coils LO1, LO2 . . . LOJ, the phase of the inductive coupling detection signal S11 obtained from the inductive coupling signal output circuit 34 of the position detection signal output unit 31, i.e. the phase of the specified position detection output signal S12 is detected in the synchronous detection circuit 37, and detecting pen pressure.

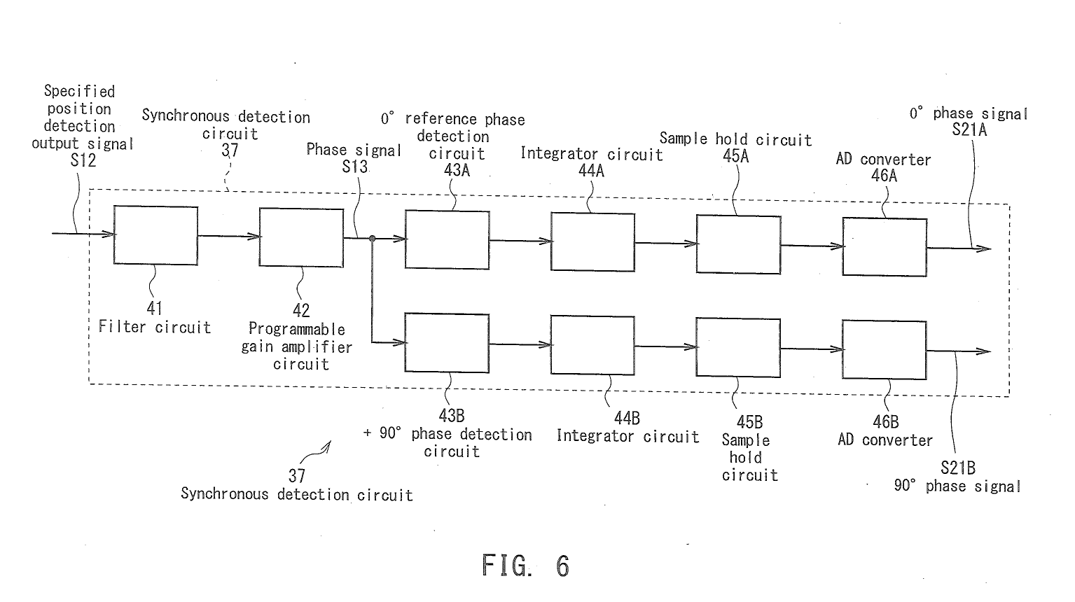

As shown in FIG. 6, the synchronous detection circuit 37 converts the specified position detection output signal S12 based on the inductive coupling detection signal S11, which is obtained from the inductive coupling signal output circuit 34, to a static coupling detection signal S13 including a 0[°], phase reference signal component and a +90[°], phase signal component, via a filter circuit 41 composed of a notch filter and a low-pass filter and a programmable gain amplifier circuit 42. Then, the synchronous detection circuit 37 separates the phase components in a 0° reference phase detection circuit 43A and a +90° phase detection circuit 43B and supplies to integrator circuits 44A and 44B, samples the integrated output in sample hold circuits 45A and 45B and holding the sampling values, and convert the sample hold values into digital values in AD converters 46A and 46B.

In this manner, a 0° phase detection signal S21A representing the reference phase component of the specified position detection output signal S12 obtained from the coordinate position carried out the pen touch operation is obtained from the AD converter 46A of the 0° reference phase side, and also a 90° phase detection signal S21B of the specified position detection output signal S12 is obtained from the AD converter 46B of the 90° phase side. These signals are transmitted as part of a specified position detection signal S14.

In the case of this embodiment, to a non-inverting input terminal of the inductive coupling signal output circuit 34 having the configuration of differential amplifier circuit (FIG. 4), the drive pulse signal S4 of the drive pulse generating circuit 24A of the drive signal input unit 21 is connected via an attenuation circuit 50. Thereby, the phase of the drive pulse signal S4 which is supplied to the input loop coils LI1, LI2 . . . LIK through the signal input switches 22Y1, 22Y3 . . . 22Y(M−5) is supplied to one differential input terminal as reference phase information, and enabling the synchronous detection circuit 37 to easily obtain the 0° phase detection signal S21A to be a reference phase and the +90° phase detection signal S21B.

### (5) Configuration of Position Detection Operation Mode by Static Coupling System

In the configuration of the X-axis line plate unit 3C and Y-axis line plate unit 3D of the XY coordinate forming unit 11 of FIG. 3, when the central processing unit 2 turns off the mode selection switches SX1, SX3, SX5 . . . SX(N−5) of the X-axis line mode switching unit 12 and also turns off the mode selection switches SY1, SY3, SY5 . . . SY(M−5) of the Y-axis line plate unit 3D, the specified position detection unit 4 performs the processing of a static coupling type position detection operation mode.

A specified position detecting operation by the XY coordinate forming unit 11 at this time is referred to as “static coupling detecting operation”.

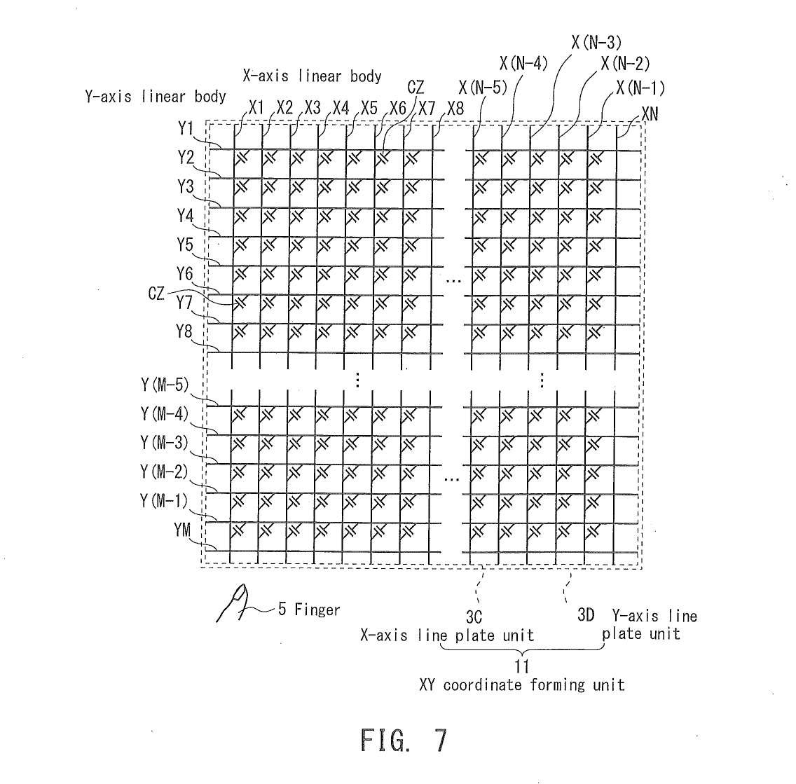

At the time, the X-axis linear bodies X1 to XN and Y-axis linear bodies Y1 to YM respectively form an XY coordinate system mutually orthogonally crossing on the X-axis line plate unit 3C and Y-axis line plate unit 3D. Thereby, as shown in FIG. 7, an electrostatic field by floating capacitance CZ is formed centering around points of intersection between the X-axis linear bodies X1 to XN and Y-axis linear bodies Y1 to YM.

In this electrostatic field, in FIG. 7, when viewed the mutually-laminated X-axis line plate unit 3C and Y-axis line plate unit 3D from the plate surface of the transparent protection glass plate member 3E, in each lattice space of the XY coordinate system, floating capacitance CZ formed between two X-axis linear bodies X(n−1) and X(n+1) and two Y-axis linear bodies Y(m−1) and Y(m+1), which are respectively adjacent as mutually facing centering around the coordinate (Xn, Ym) of an intersection, is generated in the XY coordinate system almost uniformly.

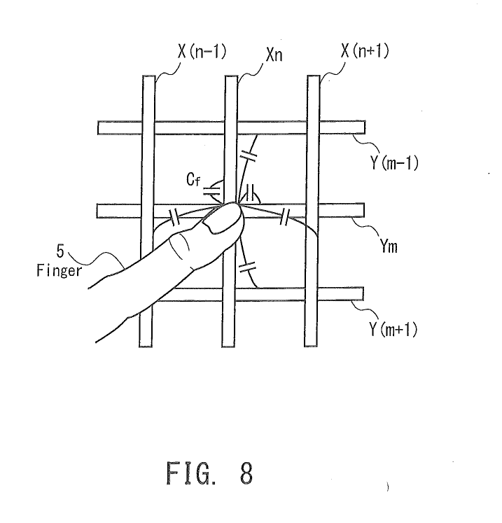

In such electrostatic field of the XY coordinate system, as shown in FIG. 8, when a user touches a coordinate (Xn, Ym) with a finger 5, the total capacitance value of floating capacitance values Cf between the X-axis linear bodies X(n−1), Xn, X(n+1) and Y-axis linear bodies Y(m−1), Ym, Y(m+1), which is at the specified position and around, is distributed.

In this state, when a drive pulse voltage is input to a Y-axis line Ym, voltage output corresponding to the floating capacitance values Cf is transmitted to an X-axis line Xn.

Thereby, with respect to the XY coordinate forming unit 11, when the central processing unit 2 sequentially turns on the signal input switches 22Y1, 22Y2 . . . 22YM of the drive signal input unit 21 and also sequentially turns on the signal output switches 32X1, 32X2 . . . 32XN of the position detection signal output unit 31 (this one cycle of on-operation is referred to as detection scanning), in the on-operated state of the signal input switch 22YM, a detection output is obtained at the time of on-operation of the signal output switch 32Xn. This output is output from the static coupling signal output circuit 36 as a static coupling detection signal S13 of the time when the coordinate position (Xn, Ym) was touched with the finger 5, and is resultingly transmitted as a specified position detection signal S14 of the position detection signal output unit 31.

In this manner, when the user performs finger touch operation with the finger 5 to a position of the operation input surface of the transparent protection glass plate member 3E, which corresponds to any position of the XY coordinate forming unit 11, an electrostatic field at the specified position can be varied to a capacitance value corresponding to the user's finger. This brings to change indicating variance of the capacitance at the output terminal of the static coupling signal output circuit 36 of the position detection signal output unit 31, and enabling to obtain a specified position detection signal S14 in a capacitance type position detection mode.

In this manner, as to the XY coordinate forming unit 11 of this embodiment, with having a single configuration that the X-axis line plate unit 3C and Y-axis line plate unit 3D are laminated with sandwiching the insulating layer material 3B therebetween, by that the mode switching unit 14 composed of the X-axis line mode switching unit 12 and Y-axis line mode switching unit 13 is subjected to switching control, a specified position detection operation in finger touch operation by static coupling system can be performed as well as a specified position detection operation in pen touch operation by inductive coupling system.

### (6) Specified Position Detection Mode Switching Processing Procedure

### (6-1) Standby Detection Operation Mode

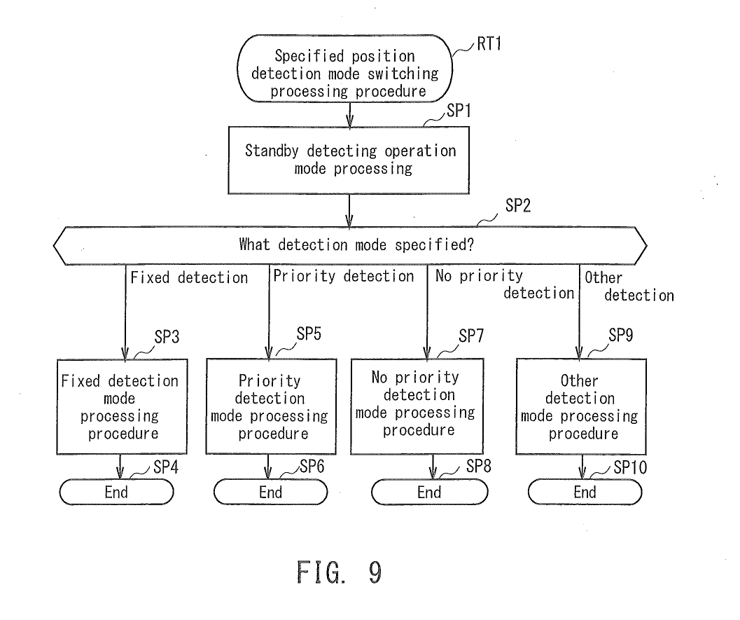

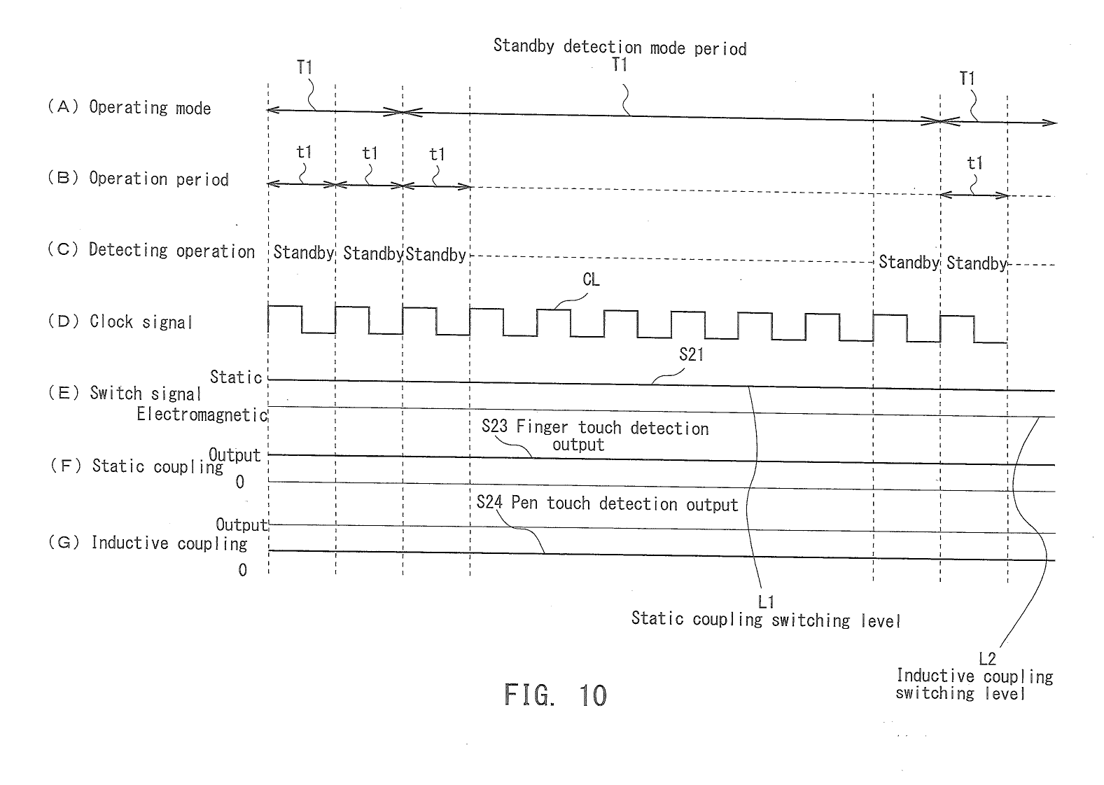

In FIG. 1, when a user specifies a specified position detection mode to the central processing unit 2, the central processing unit 2 executes a specified position detection mode switching processing procedure RT1 shown in FIG. 9 to the specified position detection control unit 7, and the specified position detection control unit 7 supplies specified position detection mode instruction signals S18 and S19 containing switching operation of a position detection mode to the drive signal input unit 21 and position detection signal output unit 31. First, in a step SP1, standby detection operation mode processing is performed.

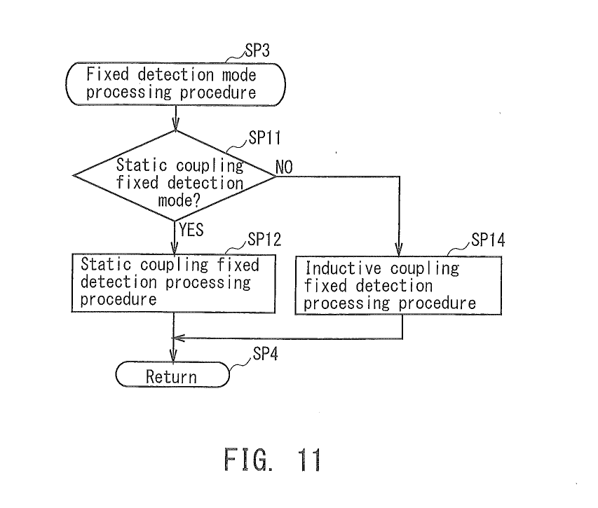

As the operation to the XY coordinate forming unit 11 by the central processing unit 2 at the time of entering the specified position detection mode switching processing procedure RT1, basically, each detection operation mode is carried out based on such operating conditions as shown in FIGS. 10A-10G as signal waveforms in the standby detection operation mode.

By executing this standby detection operation mode processing, the central processing unit 2 makes the specified position detection unit 4 possible to respond to a detection mode that will be performed by a user after that.

More specifically, as shown in FIG. 10(A), the central processing unit 2 sets a detection mode period for carrying out the specified detection mode (in this case, a standby detection mode period T1 made at the beginning of the detection operation). As to the detection mode period, one cycle of a reference clock signal CL (FIG. 10(D)) is prescribed to a reference operation period t1 for performing the specified detecting operation (FIG. 10(C)) only once. The central processing unit 2 switches a switch signal S21 (FIG. 10(E)) to a static coupling switching level L1 or an inductive coupling switching level L2 (according to the detection mode specified by the user), and generates a finger touch detection output S23 (FIG. 10(F)) (which is obtained in a static coupling detection mode) or a pen touch detection output S24 (FIG. 10(G)) (which is obtained in an inductive coupling detection mode) according to the specified position detection signal S14 which is actually obtained from the position detection signal output unit 31.

According to this, under the conditions shown in FIGS. 10A to 10F, the central processing unit 2 controls the XY coordinate forming unit 11 to operate whether as an XY coordinate system by the inductive coupling system described above with FIG. 5 or as an XY coordinate system by the static coupling system described above with FIGS. 7 and 8 (FIG. 10(C)).

The operating conditions of FIGS. 10(A) to 10(G) represent control in the standby detection operation mode processing SP1. The central processing unit 2 makes the XY coordinate forming unit 11 stand by at each reference operation period t1 (FIG. 10(B)) for one cycle of the reference clock signal CL (FIG. 10(D)), during the standby detection mode period T1 (FIG. 10(A)).

In this standby operation, the switch signal S21 is set to the static coupling switching level L1. The XY coordinate forming unit 11, however, is operated as neither the inductive coupling type XY coordinate system nor inductive coupling type XY coordinate system. Thus neither the finger touch detection output S23 (FIG. 10(F)) nor pen touch detection output S24 (FIG. 10(G)) is risen to an effective signal level.

In the standby detection operation mode processing SP1 of FIG. 9, when the user specifies an operation mode to the central processing unit 2, the central processing unit 2 determines what operation mode is specified in a processing step SP2.

In the case of this embodiment, as operation modes that the central processing unit 2 can control the XY coordinate forming unit 11, there has been set “static coupling fixed detection mode” and “inductive coupling fixed detection mode” as fixed detection modes, “standby operation mode”, “static coupling priority detection mode”, and “inductive coupling priority detection mode” as priority detection modes, “no priority detection mode”, and “other detection mode”.

### (6-2) Fixed Detection Mode

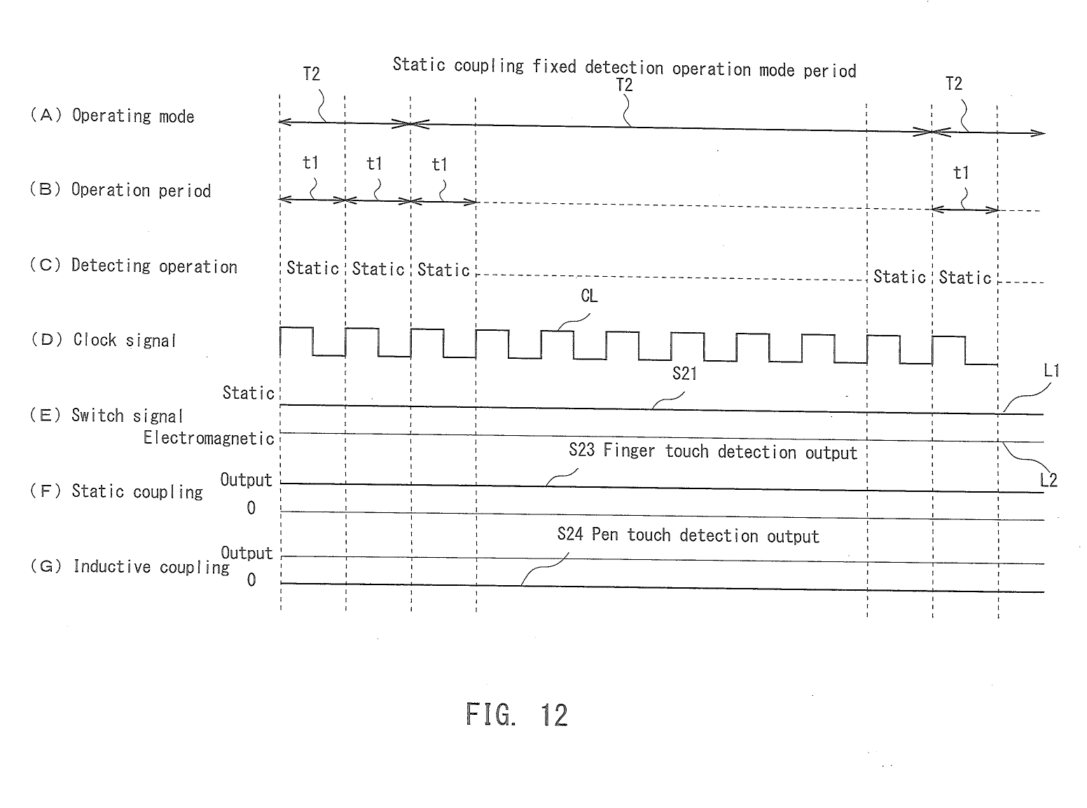

If the fixed detection mode is determined to be specified in the processing step SP2 of FIG. 9, the central processing unit 2 enters a fixed detection mode processing procedure SP3. As shown in FIG. 11, first in step SP11, the central processing unit 2 determines whether the specified fixed detection mode is the static coupling priority detection mode or not. When an affirmative result is obtained, the central processing unit 2 proceeds to step SP12 to perform a static coupling fixed detection processing procedure, and then returns to step SP3 being a main routine of FIG. 9, finishing the specified position detection mode switching processing procedure RT1.

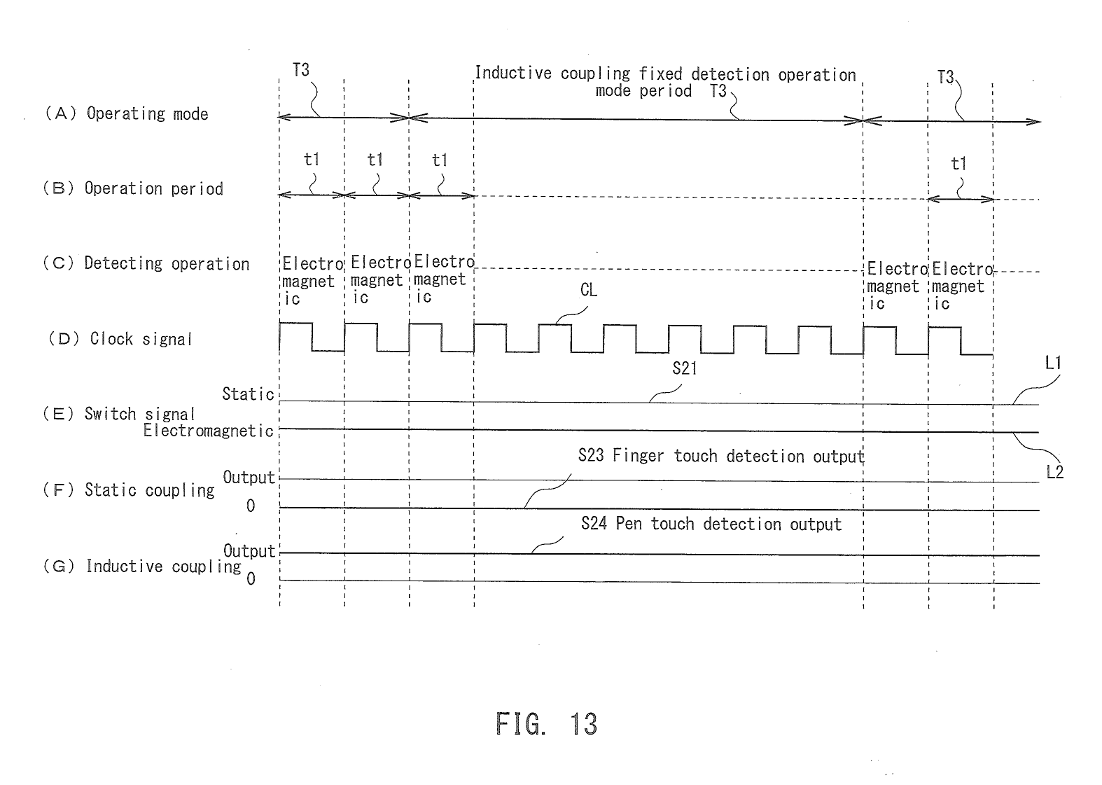

In this static coupling fixed detection processing procedure SP12, as shown in FIG. 12(C), in the static coupling fixed detection operation mode period T2, a static coupling detection operation is performed at each reference operation period t1 (FIG. 12(B)) being for one cycle of the reference clock signal CL shown in FIG. 12(D).

As this static coupling detection operation, as described with FIGS. 7 and 8, as for floating capacitance CZ between the X-axis linear bodies X1 to XN and Y-axis linear bodies Y1 to YM of the static coupling type XY coordinate system, when a user's finger 5 touches a coordinate position (Xn, Ym), as shown in FIG. 12(F), a detecting operation as obtaining a finger touch detection output S23 based on a static coupling detection signal S13 is performed.

In the static coupling fixed detection operation mode period T2, as shown in FIG. 12(E), the central processing unit 2 makes to generate a switch signal S21 set to the static coupling switching level L1 or inductive coupling switching level L2 according to the specification of the user's operating mode. When the switch signal S21 is at the static coupling switching level L1, the central processing unit 2 makes the XY coordinate forming unit 11 perform a static coupling detection operation, so that when the user performs a finger touch operation with a finger 5, a finger touch detection output S23 as shown in FIG. 12(F) is formed based on a static coupling detection signal S13 transmitted from the static coupling signal output circuit 36.

Since at this time, the XY coordinate forming unit 11 does not perform an inductive coupling detection operation, as shown in FIG. 12(G), the central processing unit 2 is in a state being unable to obtain an inductive coupling detection signal S11 from the inductive coupling signal output circuit 34, and a pen touch detection output S24 is not formed.

Accordingly, the central processing unit 2 performs the static coupling fixed detection processing procedure SP12, so that when the user performs a finger touch operation to the XY coordinate forming unit 11, the finger touch detection output S23 based on the static coupling detection signal S13 is obtained, whereas when in having no finger touch, no finger touch detection output S23 at an effective signal level is obtained.

In this manner, the central processing unit 2 continues to form a finger touch detection output S23 until the user stops the operation to specify the static coupling fixed detection mode. Whereas when the operation is stopped, the central processing unit 2 returns to step SP4 to finish the specified position detection mode switching processing procedure RT1.

On the other hand, if a negative result is obtained in step SP11 of FIG. 11, this means that the fixed operation of the fixed detection mode that the user carried out to the central processing unit 2 is the inductive coupling fixed detection mode. At this time, the central processing unit 2 proceeds to step SP14 to perform an inductive coupling fixed detection processing procedure.

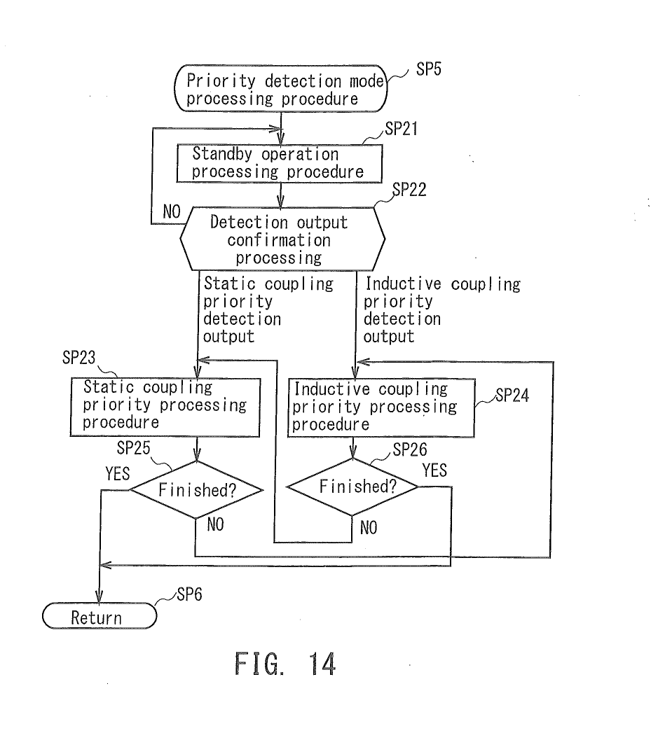

In this inductive coupling fixed detection processing procedure, as shown in FIG. 13 with adding the same numbers to the parts that correspond to FIG. 12, as described above on the inductive coupling type XY coordinate system of FIG. 5, an inductive coupling detection operation by a pen touch operation carried out with the position specifying tool 6 to the XY coordinate forming unit 11 is continuously performed (FIG. 13(C)) at each reference operation period t1 (FIG. 13(B)) of an inductive coupling fixed detection operation mode period T3 (FIG. 13(A)) (this is referred to as fixed detection operation).

In this inductive coupling fixed detection operation, the switch signal S21 is switched to the inductive coupling switching level L2, and if there is a pen touch operation by the user to the XY coordinate forming unit 11, as shown in FIG. 13(G), the pen touch detection output S24 based on the XY coordinate forming unit 11 is formed. Whereas as shown in FIG. 13(F), no finger touch detection output S23 based on the static coupling detection signal S13 is formed.

This inductive coupling fixed detection operation continues until the user stops the specification of the inductive coupling fixed detection mode to the central processing unit 2. When the operation is stopped by the user, the central processing unit 2 returns to the main routine of FIG. 9 from step SP4 and finishes the specified position detection mode switching processing procedure RT1.

### (6-3) Standby Operation Processing Operation

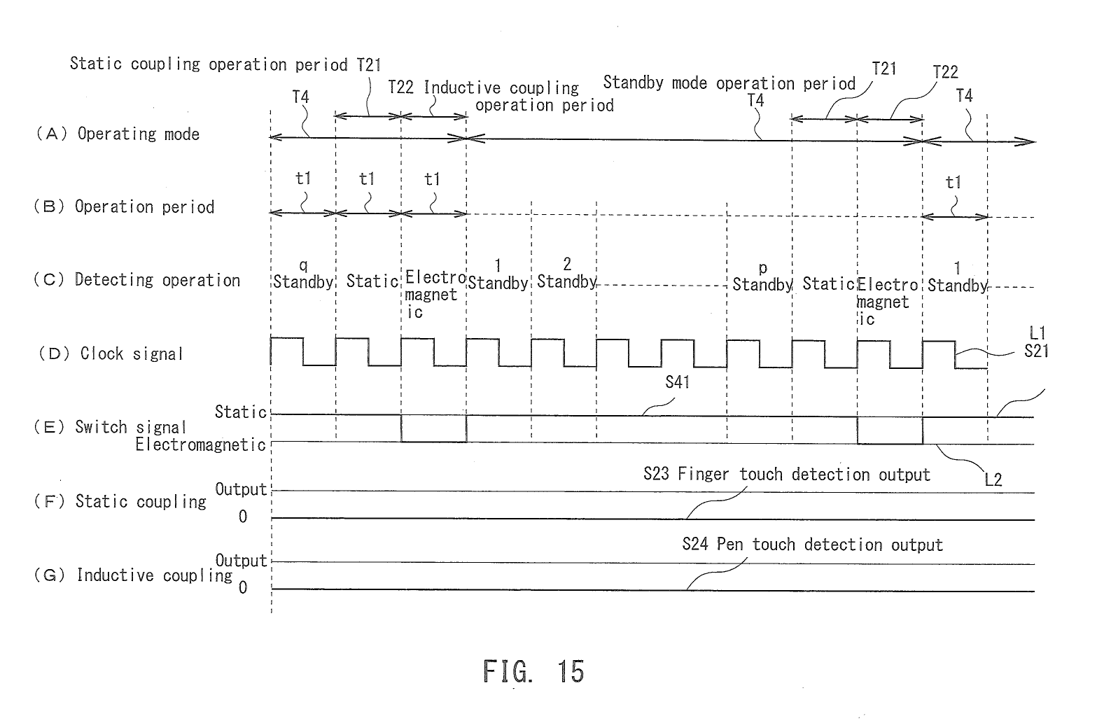

When it is determined that the user specifies the priority detection mode in step SP2 of the specified position detection mode switching processing procedure RT1 of FIG. 9, the central processing unit 2 enters a priority detection mode processing procedure RT5 shown in FIG. 14.

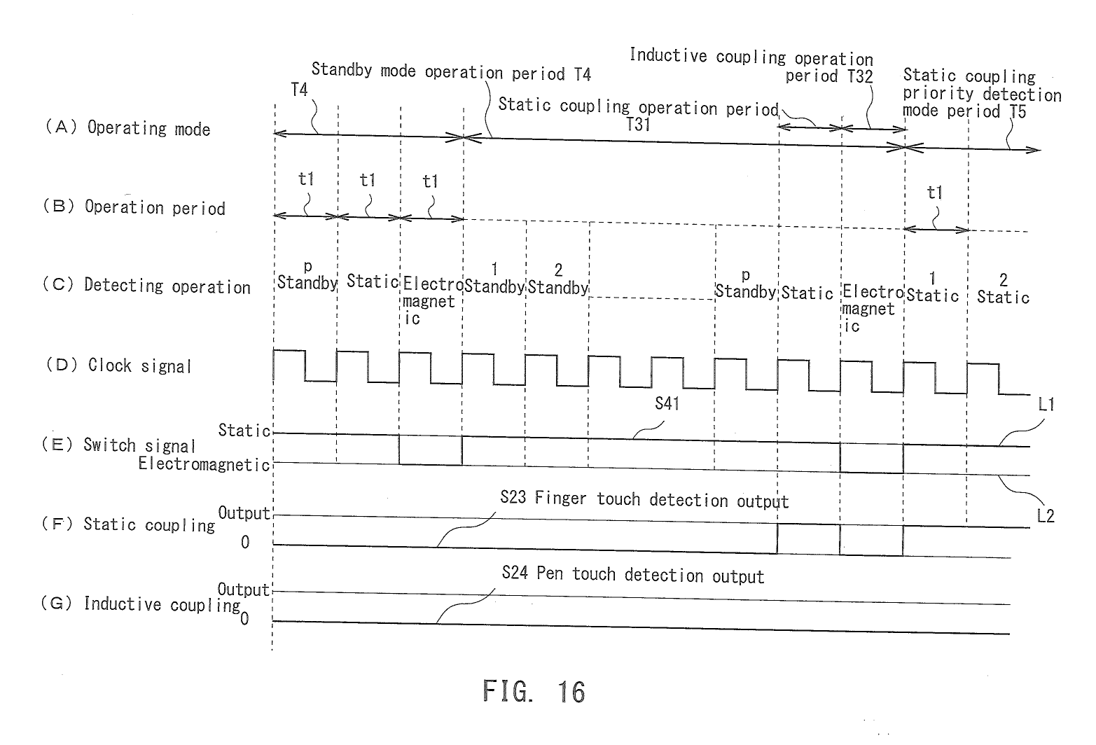

At this time, first in a standby operation processing procedure SP21, as to a standby operation mode period T4 of FIG. 15(A), as shown in FIG. 15(C), the central processing unit 2 continuously repetitively performs a standby operation for a predetermined number of times q at each reference operation period t1 of FIG. 15(B), and sequentially performs a static coupling detection operation and an inductive coupling detection operation respectively once in a static coupling operation period T21 and an inductive coupling operation period T22 between the next q times of the standby operation 1 to q.

In this q times of the standby operation, although the central processing unit 2 sets the switch signal S41 to the static coupling switching level L1 (FIG. 15(E)), it makes the XY coordinate forming unit 11 operate as neither the static coupling type XY coordinate system nor inductive coupling type XY coordinate system.

Here, that the user specifies the priority detection mode means that the user wants to use the XY coordinate forming unit 11 in either a finger touch operation mode or pen touch operation mode.

Generally, in input operation devices utilizing a touch panel, finger touch operation is more frequently used, and by that input operation of information can easily be carried out is considered, so that the frequency to detect a specified position by utilizing the XY coordinate forming unit 11 as a static coupling type XY coordinate system is expected to be selected to become a state detectable at any time.

On the other hand, generally, in the case of carrying out a pen touch operation with a position specifying tool as an electronic pen or the like, it is often used in a particular occasion such as handwriting note and writing in a picture. At this time, a good responsiveness is required.

Therefore, the detecting frequency of a specified position when a pen touch operation is carried out to the XY coordinate forming unit 11 is required to be switched to a detecting operation at a timing near the operated timing, and also it is expected that when the position specifying tool 6 left a touch operation surface, it continues the detecting operation as the inductive coupling type XY coordinate system for a certain period of time.

To properly cope with these conditions, in this embodiment, respective priority is given to the detecting frequency that makes the XY coordinate forming unit 11 operate by the static coupling system and inductive coupling system (the frequency ratio is selected to about 1 to 10-1 to 100). In addition to this, when a user specifies the priority detection mode, a static coupling detection operation and an inductive coupling detection operation are performed respectively once, between the mutual standby operations 1-q in that neither static coupling priority processing nor inductive coupling priority processing is performed, to confirm that the user specifies which detecting operation (FIG. 15(B)).

At this time, as shown in FIG. 15(E), the switch signal S41 is switched to the inductive coupling switching level L2 side in the inductive coupling operation period T22, whereas it is maintained to the static coupling detecting level L1 side during the static coupling operation period T21 and the q times of standby operation periods.

In this state, the central processing unit 2 performs detection output confirmation processing step SP22 of FIG. 14 to confirm whether the pen touch detection output S24 or finger touch detection output S23 shown in FIGS. 15G and 15F is obtained or not in the inductive coupling operation period T22 and static coupling operation period T21 (FIG. 15(A)).

If a negative result is obtained in this step SP22, the central processing unit 2 returns to the above step SP21 and repeatedly performs the standby operation processing procedure.

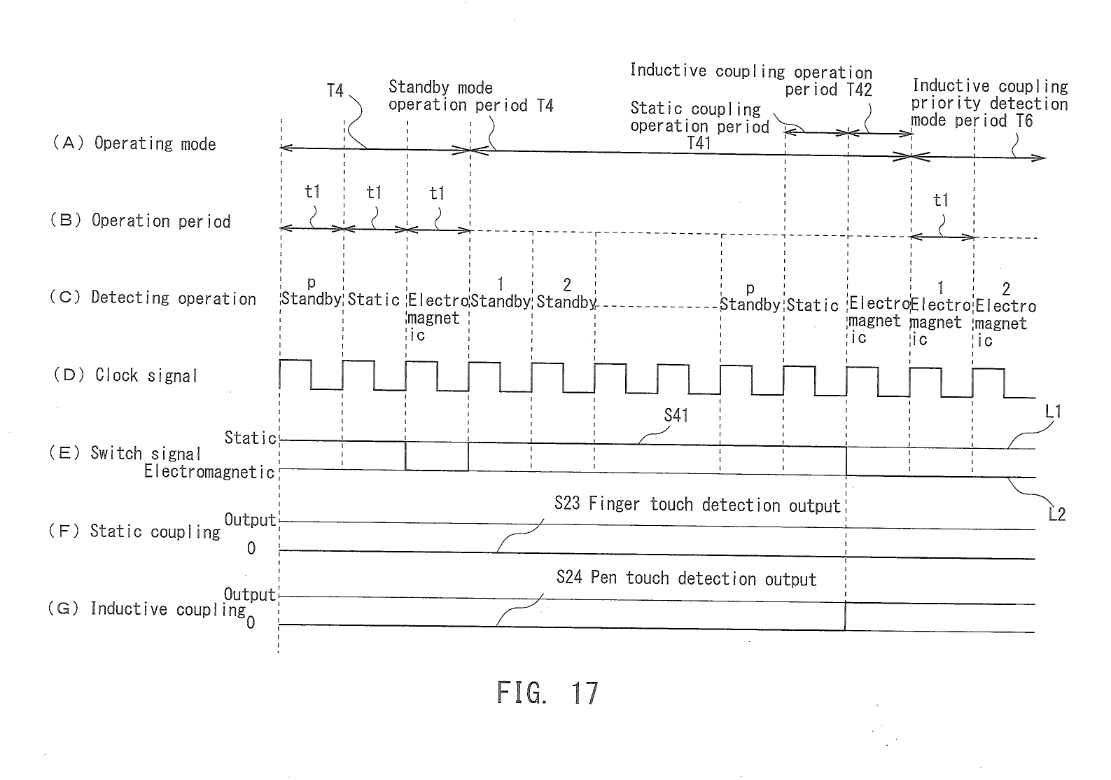

In such standby operation mode period T4, if a finger touch detection output S23 is obtained as shown in FIG. 16(F) in a static coupling operation period T31 shown in FIG. 16(A), the central processing unit 2 moves from step SP22 to step SP23 to perform a static coupling priority processing procedure and switch to a static coupling priority detection mode period T5 (FIG. 16(A)).

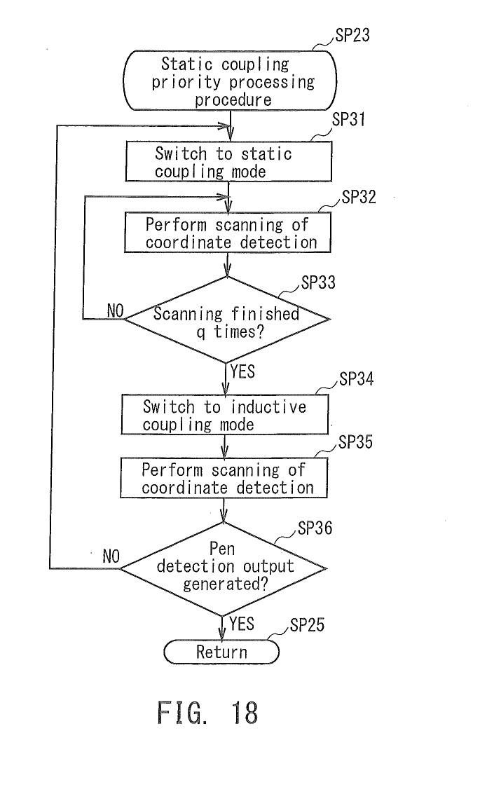

On the other hand, in an inductive coupling operation period T42 shown in FIG. 17(A), if a pen touch detection output S24 is obtained as shown in FIG. 17(G), the central processing unit 2 moves from step SP22 to step SP24 to perform an inductive coupling priority processing procedure and switch to an inductive coupling priority detection mode period T6 (FIG. 17(A)).

In this manner, in the state of making the XY coordinate forming unit 11 perform a standby operation, when the user carries out a finger touch operation or a pen touch operation to the XY coordinate forming unit 11, as responding to this, the central processing unit 2 makes the XY coordinate forming unit 11 switch to a static coupling priority detection operation state or an inductive coupling priority detection operation state.

### (6-4) Static Coupling Priority Processing Procedure

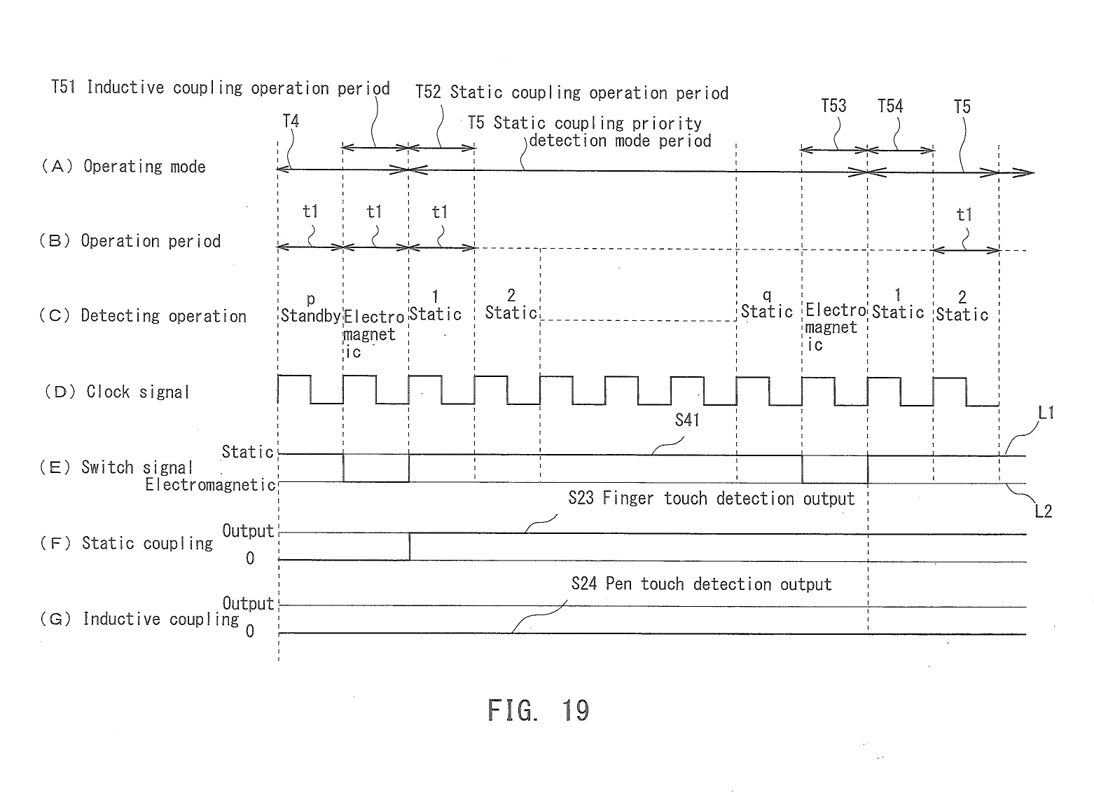

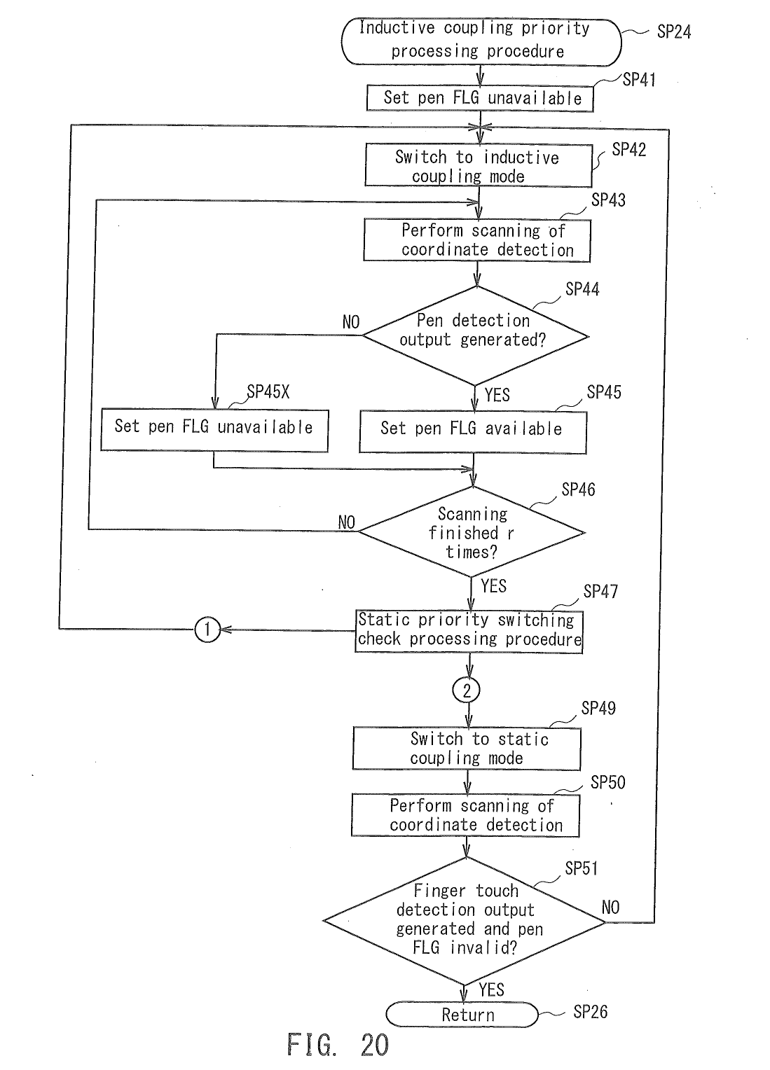

When entering the static coupling priority processing procedure SP23, as shown in FIG. 18, first in step SP31, the central processing unit 2 switches the XY coordinate forming unit 11 to the operation mode to be the static coupling type XY coordinate system described above with FIGS. 7 and 8, and then for the next static coupling priority detection mode period T5 (FIG. 19(A)), in step SP32, the central processing unit 2 performs scanning of coordinate detection once, and then in step SP33, the central processing unit 2 determines whether the scanning has finished a prescribed number of times q or not. When a negative result is obtained, the central processing unit 2 returns to the step SP32 and repeats the scanning operation of steps SP32-SP33 until the scanning finishes the prescribed number of times.

Then for an inductive coupling operation period T53 of FIG. 19(A), when an affirmative result is obtained, the central processing unit 2 switches to an inductive coupling detection mode in the next step SP34 (FIG. 19(C)), and then in step SP35, the central processing unit 2 performs scanning of coordinate detection in the inductive coupling detection mode once.

As following to this, in the next step SP36, the central processing unit 2 determines whether a pen touch detection output is generated or not, and when a negative result is obtained, it returns to the above step SP31.

In this manner, as shown in FIG. 19(C), in the static coupling priority detection mode period T5, the central processing unit 2 continues to perform a static coupling detection operation q times (FIG. 19(C)), and then in the inductive coupling operation period T53, the central processing unit 2 performs an inductive coupling detection operation (FIG. 19(E)) to determine whether the pen touch detection output S24 (FIG. 19(G)) is obtained or not.

In the case of FIG. 19, in the inductive coupling operation period T53, the finger touch detection output S23 is output, whereas no pen touch detection output S24 (FIG. 19(G)) is output, so that in step SP36, a negative result is obtained. Thereby, the central processing unit 2 returns from step SP36 to the above-described step SP31, thus repeats the static coupling detection processing q times again.

In this manner, the central processing unit 2 performs the inductive coupling operation once every q times of static coupling detection operation to prioritize the q times of static coupling detecting frequency to the one time of inductive coupling detecting frequency. Thereby, in the case of necessary to preferentially perform the finger touch detection operation such as the case of operating a general touch panel, a detection operation fit to this can be performed.

On the other hand, if an affirmative result is obtained in step SP36, for the static coupling priority detection mode period T5 (FIG. 19(A)), in the inductive coupling operation period T53 following the q times of static detection operation, the case of FIG. 19(G) shows the case where the pen touch detection output S24 is not obtained, whereas this means the case where the pen touch detection output S24 is obtained. At this time, the central processing unit 2 moves from step SP36 to step SP25 being a main routine (FIG. 14) to judge whether to finish the priority detection mode processing procedure SP5 or not. When a negative result is obtained, the central processing unit 2 proceeds to step SP24 to perform an inductive coupling priority processing procedure.

On the other hand, when an affirmative result is obtained in step SP25, the central processing unit 2 finishes the priority detection mode processing procedure SP5, and in step SP6 being a main routine of FIG. 9, the central processing unit 2 finishes the specified position detection mode switching processing procedure RT1.

### (6-5) Inductive Coupling Priority Processing Procedure

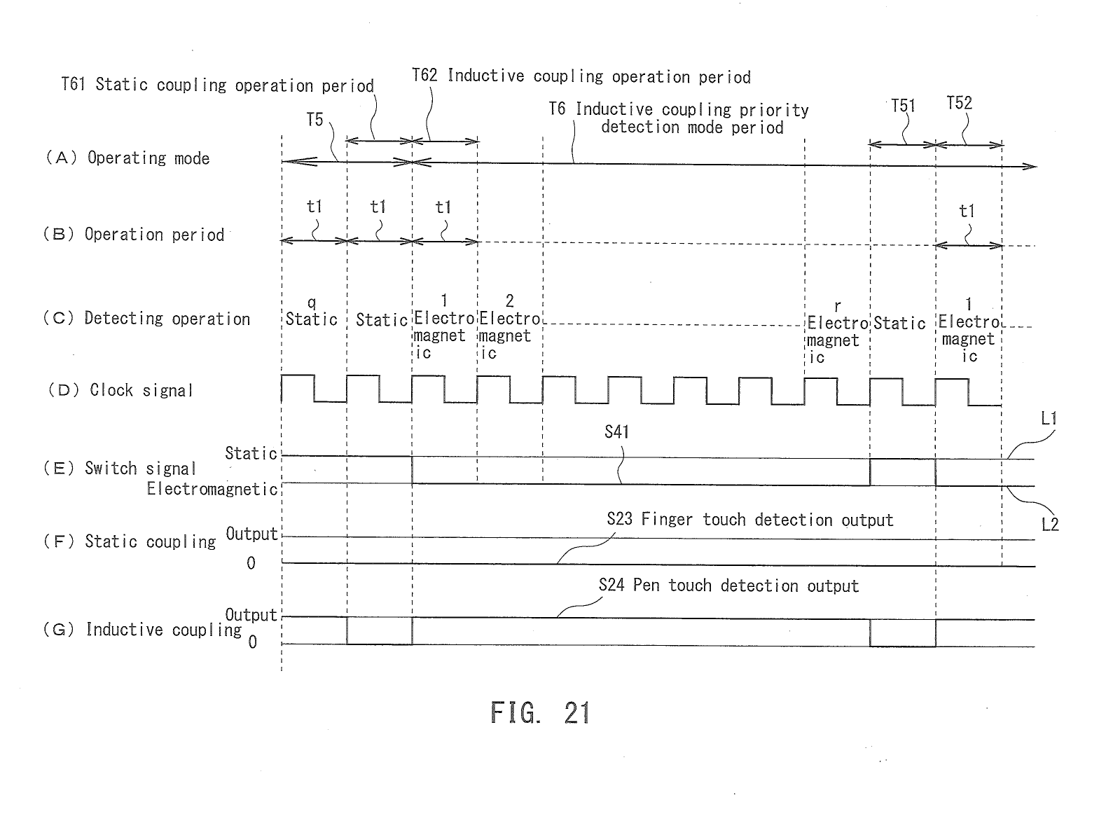

In FIG. 14, after entering the inductive coupling priority processing procedure SP24 from step SP22 or step SP25, the central processing unit 2 first proceeds to step SP41 of FIG. 20 to set a pen flag (FLG) (this is referred to as “pen FLG” too) to invalid.

Here, the pen flag (FLG) is a flag to be used for that the central processing unit 2 determines the effectiveness of a pen touch operation carried out by the user in the inductive coupling detection operation, and at the time of the pen touch operation, the central processing unit 2 displays whether a pen touch detection output S24 (FIG. 21(G)) is valid or not.

Then, when entered the inductive coupling priority processing procedure SP24, the central processing unit 2 first sets the pen FLG to invalid in step SP41. This means that the central processing unit 2 made to display that when entered the inductive coupling priority processing procedure SP24, there had not been pen touch operation before that by the pen flag (FLG).

Next, in step SP42, the central processing unit 2 switches the XY coordinate forming unit 11 to a mode which is made to operate as the inductive coupling type XY coordinate system described above with FIG. 5, and in the next step SP43, the central processing unit 2 performs the scanning of coordinate detection.

As shown in FIG. 21(A), the operation of the central processing unit 2 at this time shows that when a switch signal S41 was switched from the static coupling switching level L1 to the inductive coupling switching level L2 in an inductive coupling operation period T62 in the last static coupling priority detection mode period T5, the user did not carry out finger touch operation (FIG. 21(F)) but carried out a pen touch operation. Accordingly, the central processing unit 2 came into the state of forming the pen touch detection output S24 by the processing of step SP43 in the inductive coupling operation period T62.

Thereby, when a pen touch operation is carried out with the position specifying tool 6 to the XY coordinate forming unit 11, it comes into the state where the pen touch detection output S24 (FIG. 21(G)) is transmitted from the position detection signal output unit 31 to the central processing unit 2.

Next, in step SP44, the central processing unit 2 determines whether a pen touch detection output is generated or not.

When an affirmative result is obtained in the step SP44, the central processing unit 2 proceeds to step SP45 to set the pen flag (FLG) to a valid level and proceeds to step SP46, whereas when a negative result is obtained, it sets the pen flag (FLG) to an invalid level in step SP45X and then proceeds to step SP46.

Here, when in performing the processing of step SP46, when the pen touch detection output S24 (FIG. 21(G)), which was actually generated based on the inductive coupling detection signal S11 is obtained, the central processing unit 2 sets the pen flag (FLG) to the valid level, whereas when in obtaining no pen touch detection output S24, the central processing unit 2 sets the pen flag (FLG) to the invalid level.

The reason to display the state of pen touch with the pen flag (FLG) is that although the state of pen touch is unstable in reality and the position specifying tool 6 sometimes jumps up and down and leaves from the operation display surface of the XY coordinate forming unit 11, even so, the thing that the user carries out a pen touch operation can be accurately reflected in the valid or invalid state of the pen flag (FLG).

In step SP46, the central processing unit 2 determines whether the number of times of scanning being the number of times of inductive coupling detection operation reaches a prescribed value r times or not. When a negative result is obtained, the central processing unit 2 returns to the above-described step SP43 and repeats the scanning operation of coordinate detection.

In this manner, by that as shown in FIG. 21, in the inductive coupling priority detection mode period T6 (FIG. 21(A)), when the pen touch detection output S24 (FIG. 21(G)) was obtained in the inductive coupling operation period T62, the central processing unit 2 set the pen flag (FLG) to valid in step SP45, the central processing unit 2 repeats the coordinate detection scanning operation through the loop of steps SP46-SP43 and leads to perform the prescribed number of times r of the inductive detection operation (FIG. 21(C)).

If an affirmative is obtained in step SP46, the central processing unit 2 proceeds to the next step SP47 to perform static priority switching check processing.

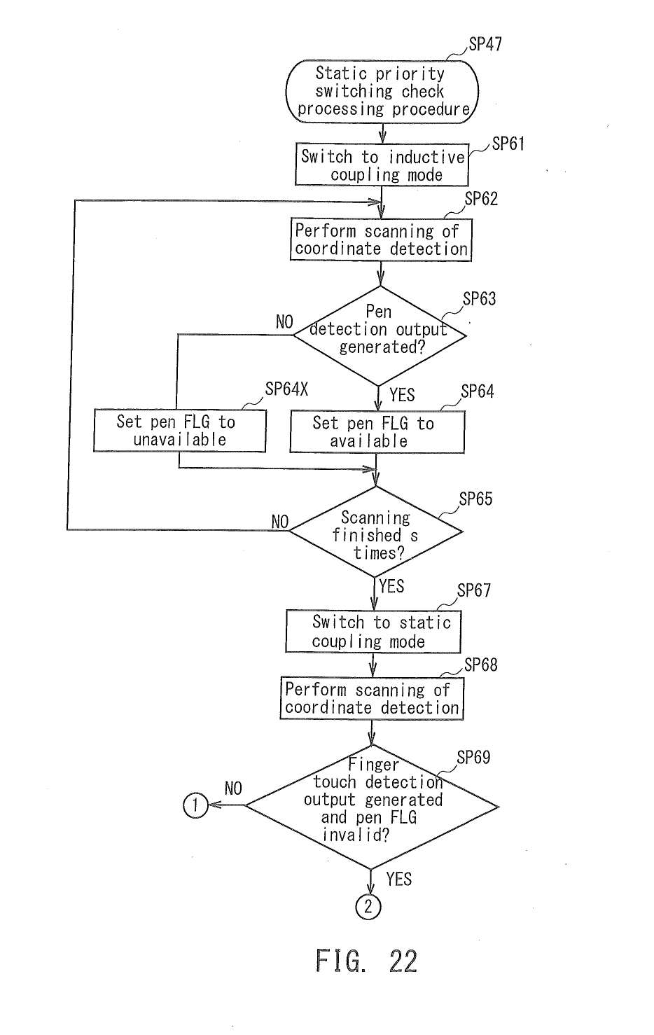

The static priority switching check processing procedure SP47 is processing to confirm the suitability at the time of switching the mode to the static coupling detection mode in the inductive coupling priority detection mode period T6. As shown in FIG. 22, first in step SP61, the central processing unit 2 switches the XY coordinate forming unit 11 to the inductive coupling detection mode.

Next, in step SP62, the central processing unit 2 performs the scanning of coordinate detection, and then in step SP63, the central processing unit 2 determines whether the pen touch detection output S24 has been generated or not.

When an affirmative result is obtained here, in step SP64, the central processing unit 2 sets the pen flag (FLG) to valid, and then in step SP65, the central processing unit 2 determines whether the scanning has finished s times or not.

On the other hand, in step SP63, when a negative result is obtained, in step SP64X, the central processing unit 2 sets the pen flag (FLG) to invalid.

In this manner, in steps SP64 and SP64X, the central processing unit 2 resets the pen flag (FLG) as indicating the presence of the pen touch detection output S24 that has been actually generated based on the inductive coupling detection signal S11.

If a negative result is obtained in step SP65, the central processing unit 2 returns to the above-described step SP62 and repeats the processing of steps SP62 to SP65.

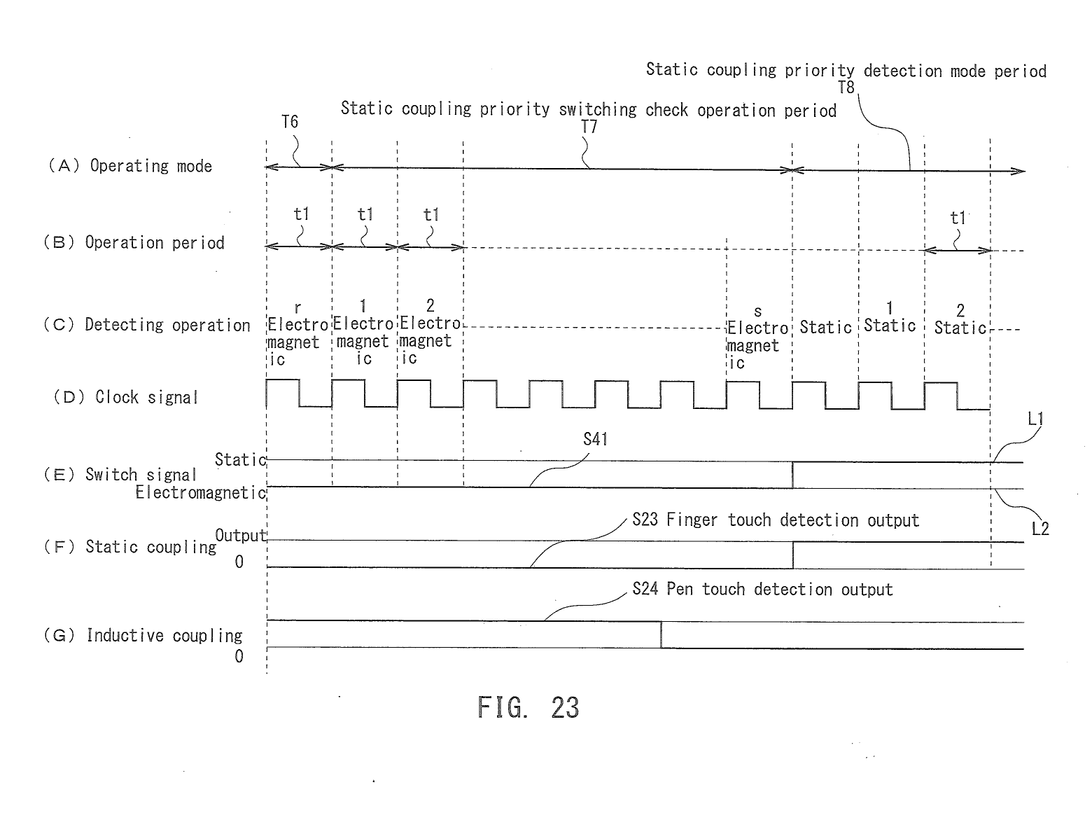

In this manner, as shown in FIG. 23, for the static coupling priority switching check operation period T7 (FIG. 23A), the central processing unit 2 performs the s times of inductive coupling detection operation (FIG. 23C).

In the static coupling priority switching check operation period T7, the switch signal S41 has been switched to the inductive coupling switching level L2 side (FIG. 23E), so that it becomes the state of no detection output of the finger touch detection output S23 (FIG. 23F), whereas a detection output of the pen touch detection output S24 (FIG. 23G) becomes sometimes not to be obtained during the s times of inductive coupling detection operation.

In such state, the central processing unit 2 switches the detection operation of the XY coordinate forming unit 11 to the static coupling detection mode in the next step SP67, and then in step SP68, the central processing unit 2 performs the scanning of coordinate detection, so that the occurrence of an actual finger touch operation in the static coupling detection mode can be detected.

This detection result is confirmed by that the central processing unit 2 determines whether or not a finger touch detection output has been generated and the pen flag (FLG) is invalid in step SP69.

If the central processing unit 2 obtains an affirmative result in the determining result in step SP69, this means that a finger touch operation has been actually carried out and also a pen touch detection output is an invalid state (thus pen touch operation has not been carried out). At this time, the central processing unit 2 moves from a processing operation node “2” to the processing step SP49 of the inductive coupling priority processing procedure SP24 (FIG. 20) to perform processing to switch the XY coordinate forming unit 11 to the static coupling operation mode.

Following this processing, the scanning of coordinate detection is performed in step SP50 so that a detection operation to confirm whether the user carries out a finger touch operation to the XY coordinate forming unit 11 or not. In the next step SP51, the central processing unit 2 determines whether or not a touch detection output has been generated and the pen flag (FLG) is invalid.

If an affirmative result is obtained here, this means that the user actually carries out a finger touch operation in the static coupling operation mode. At this time, the central processing unit 2 returns to the processing step SP26 of the priority detection mode processing procedure SP5 (FIG. 14).

In this processing step SP26, the central processing unit 2 determines whether the user specified the finish of the priority detection processing mode. When a negative result is obtained, the central processing unit 2 proceeds to the above-described static coupling priority processing procedure SP23 to switch the XY coordinate forming unit 11 from the inductive coupling priority processing operating state to the static coupling priority processing procedure operating state.

On the other hand, when a negative result is obtained in step SP51, this means that the finger touch detection output has not been generated or the pen flag (FLG) is not at the invalid level, thus the user actually carries out a pen touch operation to the XY coordinate forming unit 11. At this time, the central processing unit 2 returns to the above-described processing step SP42 and changes to the state of making the XY coordinate forming unit 11 operate in the inductive coupling detection mode in the processing steps SP42 to SP46 again.

In this manner, the central processing unit 2 performs the processing of steps SP42 to SP46 of the inductive coupling priority processing procedure SP24, and then performs the processing from the static priority switching check processing procedure SP47 to step SP51 to confirm whether the static coupling priority detection operation is necessary or not. If necessary, the central processing unit 2 proceeds to the static coupling priority processing, whereas if unnecessary, it repeats the inductive coupling priority processing.

Therefore, by accurately corresponding to whether the user's touch operation to the XY coordinate forming unit 11 is finger touch operation or pen touch operation, it can make the XY coordinate forming unit 11 function as the operation input means of the static coupling type XY coordinate system or inductive coupling type XY coordinate system.

### (6-6) No Priority Processing Procedure

In the processing step SP2 of FIG. 9, if detecting that the no priority detection mode was specified, the central processing unit 2 performs a no priority detection mode processing procedure in step SP7, and finishes the specified position detection mode switching processing procedure RT1 in step SP8.

At this time, the central processing unit 2 alternately performs the static coupling processing procedure and inductive coupling processing procedure every unit processing time. The detecting frequency of each unit processing time is defined as a predetermined value to each processing procedure.

The detecting frequency in the unit processing time is for example defined as 10 [number of times/sec] in the static coupling processing procedure, and 50 [number of times/sec] in the inductive coupling processing procedure.

Accordingly, according to the no priority detection mode processing procedure, in such a case that the user carries out an input operation to the display operating surface of the XY coordinate forming unit 11 with an electronic pen while “touching by mistake”, the results of specified position detection operation by the static coupling system and the results of specified position detection by the electromagnetic coupling system can be accurately obtained at the prescribed priority levels.

### (6-7) Other Detection Mode Processing Procedure

When a detection mode other than the “fixed detection” operation mode, “priority detection” operation mode, and “no priority detection” operation mode was specified by the user, the central processing unit 2 performs the other detection mode processing procedure in the processing step SP9, and then finishes the specified position detection mode switching processing procedure RT1 in step SP10.

This enables to rightly obtain the results of the specified position detection operation for an input operation performed by the user to the XY coordinate forming unit 11.

(6-8) According to the above-described specified position detection mode switching processing procedure, the static coupling detection operation and inductive coupling detection operation to the XY coordinate forming unit 11 can be switchingly performed depending on a way of specifying input by the user to the central processing unit 2, by the switching operation of the X-axis line mode switching unit 12 and Y-axis line mode switching unit 13, as the static coupling fixed detection operation, inductive coupling fixed detection operation, standby operation processing operation, static coupling priority processing operation, and inductive coupling priority processing operation. This enables to realize such specified position detection device that can make to accurately correspondingly operate depending on user's finger touch operation or pen touch operation, in accordance with the user's needs, with the simple configuration laminated the X-axis line plate unit 3C and Y-axis line plate unit 3D with sandwiching the Insulating layer material 3B therebetween.

### (7) Other Embodiments

(7-1) In the above embodiment, the drive signal input unit 21 is provided for the Y-axis line plate unit 3D of the XY coordinate forming unit 11 and also the position detection signal output unit 31 is provided for the X-axis line plate unit 3C. However, the same operation and effect as the above case can be obtained by mutually switching them and providing the position detection signal output unit 31 for the Y-axis line plate unit 3D and the drive signal input unit 21 for the X-axis line plate unit 3C.

(7-2) In the above embodiment, it has dealt with the case where linear bodies are utilized as the X-axis line plate unit 3C and Y-axis line plate unit 3D. However, the same effect as the above case can be obtained by applying strip-shaped linear bodies. Furthermore, the same effect as the above case can be obtained by applying strip-shaped linear bodies in which fine lines are joined in latticed pattern.

(7-3) In the above embodiment, it has dealt with the case where the series resonance circuit of the induction coil 6A and resonance capacitor 6B is utilized as the pen type position specifying tool 6. However, various configuration of a position specifying tool 6 may be applied. To be brief, the same operation and effect as the above case can be obtained by applying a device having such configuration that when an input transmit signal is supplied to input loop coils LI1-LIK, induction voltage is generated at output loop coils LO1-LOJ crossing to the input loop coils LI1-LIK via a position specifying tool 6.

(7-4) In the above embodiment, as the XY coordinate forming unit 11 forming the inductive coupling type XY coordinate system of FIG. 5, among the N X-axis linear bodies X1-XN and M Y-axis linear bodies Y1-YM, the output loop coils LO1-LOJ and input loop coils LI1-LIK are formed by two linear bodies sandwiching four linear bodies therebetween. However, the number of linear bodies to be sandwiched is not only limited to four, and the same effect as the above case can be obtained even if it is zero to three or five or more.

### INDUSTRIAL APPLICABILITY

The present invention can be used to input a touch input signal to an information processing device having a tablet display surface.

### EXPLANATION OF REFERENCE SYMBOLS

1: Information processing device
2: Central processing unit
3: Tablet display plate unit
3A: Information display plate unit
3B: Insulating layer material
3C: X-axis line plate unit
3D: Y-axis line plate unit
3E: Transparent protection glass plate member
4: Specified position detection unit
5: Finger
6: Position specifying tool
11: XY coordinate forming unit
12: X line mode switching unit
13: Y-axis line mode switching unit
14: Mode switching processing unit
21: Drive signal input unit
22Y1 to 22YM: Signal input switch
23: Common signal line
24: Input drive pulse generating circuit
25: Common signal line
31: Position detection signal output unit
32X1 to 32XN: Signal output switch
33: Common signal line
34: Inductive coupling signal output circuit
36: Electrostatic coupling signal output circuit
37: Synchronous detection circuit
X1 to XN: X-axis linear body
Y1 to YM: Y-axis linear body
LI1 to LIK: Input loop coil
LO1 to LIJ: Output loop coil

1-6. (canceled)

7. A specified position detecting device comprising:
an XY coordinate forming unit having a configuration mutually crossing X-axis linear bodies formed by a plurality of linear bodies and Y-axis linear bodies formed by a plurality of linear bodies;
a drive signal input unit, provided on either one terminal side of the X-axis linear bodies and Y-axis linear bodies, for inputting a drive input signal;
a position detection signal output unit, provided on either the other terminal side of the X-axis linear bodies and Y-axis linear bodies, when an XY coordinate position on the XY coordinate forming unit is specified with a position specifying means, for outputting a position detection signal corresponding to the specified coordinate position;
a first mode switching unit provided on the other terminal side of the axis linear bodies and Y-axis linear bodies in that the drive signal input unit is not provided; and
a second mode switching unit provided on the other terminal side of the X-axis linear bodies and Y-axis linear bodies in that the position detection signal output unit is not provided,
characterized in that: the drive signal input unit, position detection signal output unit, first mode switching unit, and second mode switching unit make to perform a static coupling priority detection operation, so that a percentage of the period set to the operation state permitting finger touch input operation in a static coupling detection mode is increased than pen touch input operation in an inductive coupling detection mode, for each unit time required for a specified position detection operation on the XY coordinate forming unit.

8. A specified position detecting device comprising:
an XY coordinate forming unit having a configuration mutually crossing X-axis linear bodies being a plurality of linear bodies and Y-axis linear bodies being a plurality of linear bodies;
a drive signal input unit, provided on either one terminal side of the X-axis linear bodies and Y-axis linear bodies, for inputting a drive input signal;
a position detection signal output unit, provided on either the other terminal side of the X-axis linear bodies and Y-axis linear bodies, when an XY coordinate position on the XY coordinate forming unit is specified with a position specifying means, for outputting a position detection signal corresponding to the specified coordinate position;
a first mode switching unit provided on the other terminal side of the axis linear bodies and Y-axis linear bodies in that the drive signal input unit is not provided; and
a second mode switching unit provided on the other terminal side of the X-axis linear bodies and Y-axis linear bodies in that the position detection signal output unit is not provided,
characterized in that: the drive signal input unit, position detection signal output unit, first mode switching unit, and second mode switching unit make to perform an inductive coupling priority detection operation, so that a percentage of the period set to the operation state permitting pen touch input operation in an inductive coupling detection mode is increased than finger touch input operation in a static coupling detection mode, for each unit time required for a specified position detection operation on the XY coordinate forming unit.

9. A specified position detecting device comprising:
an XY coordinate forming unit having a configuration mutually crossing X-axis linear bodies formed by a plurality of linear bodies and Y-axis linear bodies formed by a plurality of linear bodies;
a drive signal input unit, provided on either one terminal side of the X-axis linear bodies and Y-axis linear bodies, for inputting a drive input signal;
a position detection signal output unit, provided on either the other terminal side of the X-axis linear bodies and Y-axis linear bodies, when an XY coordinate position on the XY coordinate forming unit is specified with a position specifying means, for outputting a position detection signal corresponding to the specified coordinate position;
a first mode switching unit provided on the other terminal side of the X-axis linear bodies and Y-axis linear bodies in that the drive signal input unit is not provided; and
a second mode switching unit provided on the other terminal side of the X-axis linear bodies and Y-axis linear bodies in that the position detection signal output unit is not provided,
characterized in that: when specified position detection operation is started, the drive signal input unit, position detection signal output unit, first mode switching unit, and second mode switching unit perform a standby operation to detect and confirm whether a user carried out a specifying input of static coupling detection or a specifying input of inductive coupling detection, and after the standby operation, perform a static coupling priority detection operation or an inductive coupling priority detection operation according to the confirmation result.

10. The specified position detecting device according to claim 7, characterized in that,
the XY coordinate forming unit comprises an X-axis line plate unit formed by disposing the X-axis linear bodies, and a Y-axis line plate unit formed by disposing the Y-axis linear bodies, and has a configuration laminating the X-axis line plate unit and Y-axis line plate unit with sandwiching insulating layer material therebetween.

11. The specified position detecting device according to claim 7, characterized in that:
the drive signal input unit sequentially selects two from among each one terminal of the connected linear bodies and inputs the drive input signal thereto, and the first mode switching unit respectively connects each the other terminal of the above two sequentially-selected linear bodies, and forming a loop coil for input signal input by the above two linear bodies; the position detection signal output unit sequentially selects two from among the connected linear bodies and outputs the position detection signal thereto, and the second mode switching unit connects each the other terminal of the above two selected linear bodies, and forming a loop coil for position detection signal output by the above two linear bodies; and when an XY coordinate position on the XY coordinate forming unit is specified with the position specifying means of pen touch type, an input signal input from the formed loop coil for input signal input is transmitted to the loop coil for the position detection signal output via the position specifying means, and outputting the signal from the position detection signal output unit as a pen touch operation detection output in an inductive coupling detection mode.

12. The specified position detecting device according to claim 7, characterized in that,
in the operating state that the linear bodies are unconnected by the first and second mode switching units, the drive signal input unit sequentially inputs the drive input signal to one terminal of the connected linear bodies, and when an XY coordinate position on the XY coordinate forming unit is specified with a user's finger as the position specifying means, the drive input signal which is input from the drive signal input unit and transmitted while undergoing change of stray capacitance between the linear bodies occurred by the user's finger is output from the position detection signal output unit as a finger touch operation detection output in a static coupling detection mode.

13. The specified position detecting device according to claim 8, characterized in that,
the XY coordinate forming unit comprises an X-axis line plate unit formed by disposing the X-axis linear bodies, and a Y-axis line plate unit formed by disposing the Y-axis linear bodies, and has a configuration laminating the X-axis line plate unit and Y-axis line plate unit with sandwiching insulating layer material therebetween.

14. The specified position detecting device according to claim 8, characterized in that:
the drive signal input unit sequentially selects two from among each one terminal of the connected linear bodies and inputs the drive input signal thereto, and the first mode switching unit respectively connects each the other terminal of the above two sequentially-selected linear bodies, and forming a loop coil for input signal input by the above two linear bodies; the position detection signal output unit sequentially selects two from among the connected linear bodies and outputs the position detection signal thereto, and the second mode switching unit connects each the other terminal of the above two selected linear bodies, and forming a loop coil for position detection signal output by the above two linear bodies; and when an XY coordinate position on the XY coordinate forming unit is specified with the position specifying means of pen touch type, an input signal input from the formed loop coil for input signal input is transmitted to the loop coil for the position detection signal output via the position specifying means, and outputting the signal from the position detection signal output unit as a pen touch operation detection output in an inductive coupling detection mode.

15. The specified position detecting device according to claim 8, characterized in that,
in the operating state that the linear bodies are unconnected by the first and second mode switching units, the drive signal input unit sequentially inputs the drive input signal to one terminal of the connected linear bodies, and when an XY coordinate position on the XY coordinate forming unit is specified with a user's finger as the position specifying means, the drive input signal which is input from the drive signal input unit and transmitted while undergoing change of stray capacitance between the linear bodies occurred by the user's finger is output from the position detection signal output unit as a finger touch operation detection output in a static coupling detection mode.

16. The specified position detecting device according to claim 9, characterized in that,
the XY coordinate forming unit comprises an X-axis line plate unit formed by disposing the X-axis linear bodies, and a Y-axis line plate unit formed by disposing the Y-axis linear bodies, and has a configuration laminating the X-axis line plate unit and Y-axis line plate unit with sandwiching insulating layer material therebetween.

17. The specified position detecting device according to claim 9, characterized in that:
the drive signal input unit sequentially selects two from among each one terminal of the connected linear bodies and inputs the drive input signal thereto, and the first mode switching unit respectively connects each the other terminal of the above two sequentially-selected linear bodies, and forming a loop coil for input signal input by the above two linear bodies; the position detection signal output unit sequentially selects two from among the connected linear bodies and outputs the position detection signal thereto, and the second mode switching unit connects each the other terminal of the above two selected linear bodies, and forming a loop coil for position detection signal output by the above two linear bodies; and when an XY coordinate position on the XY coordinate forming unit is specified with the position specifying means of pen touch type, an input signal input from the formed loop coil for input signal input is transmitted to the loop coil for the position detection signal output via the position specifying means, and outputting the signal from the position detection signal output unit as a pen touch operation detection output in an inductive coupling detection mode.

18. The specified position detecting device according to claim 9, characterized in that,
in the operating state that the linear bodies are unconnected by the first and second mode switching units, the drive signal input unit sequentially inputs the drive input signal to one terminal of the connected linear bodies, and when an XY coordinate position on the XY coordinate forming unit is specified with a user's finger as the position specifying means, the drive input signal which is input from the drive signal input unit and transmitted while undergoing change of stray capacitance between the linear bodies occurred by the user's finger is output from the position detection signal output unit as a finger touch operation detection output in a static coupling detection mode.
